(19) United States
(12) Patent Application Publication
(10) Pub. No.: US 2011/0070429 A1
(43) Pub. Date: Mar. 24, 2011

(54) Corrosion-resistant coating for active metals

(75) Inventors: Thomas H. Rochester, Jackson, MI (US); Zachary W. Kennedy, Perry, MI (US)

(73) Assignee: Thomas H. Rochester, Jackson, MI (US)

(21) Appl. No.: 12/586,246

(22) Filed: Sep. 18, 2009

(51) Int. Cl. C23F 11/00; B05D 3/02; B32B 27/00

(52) U.S. Cl. 428/336; 427/372.2; 428/689; 524/435; 524/398; 428/446

(57) ABSTRACT

A corrosion-protection composition that generally includes a water-soluble trivalent chromium salt and a water-soluble polymer is disclosed. The composition preferably is in the form of an aqueous solution (i.e., the composition additionally includes water as a solvent) that can be applied to an active-metal substrate to form a coated substrate and a corrosion-protection film upon drying. Additional ingredients in the corrosion-protection composition can include a second water-soluble salt (e.g., cobalt, manganese, nickel, and/or iron salts), a crosslinking agent, and/or a coloring agent. The corrosion-protection composition is substantially free of hexavalent chromium, capable of forming a film on an active-metal substrate, and is substantially non-reactive with the active-metal substrate. Once applied, the corrosion protection-film is resistant to moisture.

### BACKGROUND OF THE DISCLOSURE

1. Field of the Disclosure

This disclosure relates to corrosion resistant finishes for active metals such as zinc, cadmium, magnesium, aluminum, alloys thereof, and mixtures thereof. Active metals are often applied to steel or other ferrous substrates as a sacrificial coating for corrosion protection. More specifically, the disclosure relates to a corrosion-protection composition for active metals that includes a water-soluble polymer and a water-soluble trivalent chromium salt in an aqueous film-forming composition. The composition can include a variety of optional components, such as other water-soluble salts (e.g., cobalt, manganese, nickel, iron salts). Upon environmental exposure or other exposure to moisture, the coating generates trace quantities of hexavalent chromium, providing inhibitive protection for the active metal.

2. Brief Description of Related Technology

Metal substrates, for example iron or steel parts such as nails, screws, washers, etc., may be provided with a sacrificial coating to prevent corrosion of the substrate. A sacrificial coating (e.g., formed from an active metal such as zinc) is chemically more active than the substrate it protects and corrodes rapidly/preferentially upon environmental exposure relative to its underlying substrate (i.e., it “sacrifices” itself to protect the substrate). The processes by which such coatings are applied include hot-dip galvanizing, mechanical deposition, electroplating, etc. A number of treatments improve the corrosion protection offered by these active metals; most of these treatments function by delaying the onset of the attack of the environment on the active metal surface and/or by inhibiting the attack of the environment on the active metal surface.

A method of corrosion protection (e.g., by delaying the onset of white corrosion products, as the corrosion products of zinc are called) has been the application of chromium-based coatings on substrates such as zinc, cadmium, aluminum, and magnesium. Such chromium-based coatings generally fall into one of three classes: (1) hexavalent chromium (or chromate) conversion coatings; (2) no-rinse hexavalent chromium-containing coatings; and (3) trivalent chromium conversion coatings. A hexavalent conversion coating (or chromate) is formed on a metal substrate by immersing the substrate in an acidic solution comprising chromic acid or a hexavalent chromium salt with at least one activating anion. Similarly, a trivalent conversion coating involves an acidic solution with a source of trivalent chromium and an activating ion. A trivalent passivate refers to a trivalent chromium-containing coating that is free from hexavalent chromium at the time of application but not necessarily thereafter.

Conventional hexavalent conversion coatings (e.g., for zinc) may be classified as follows: (1) yellow chromates (sulfate or nitrate activating ion; thickness: 0.25-1.0 micrometers; salt spray protection: 100-200 hours); (2) olive drab chromates (formate or phosphate activating ion; thickness: up to 1.5 micrometers; salt spray protection: 200-400 hours); (3) silver black chromates (nitrate or sulfate activating ion; thickness: 0.25-1.0 micrometers; salt spray protection: 50-150 hours); (4) (bright) blue chromates (fluoride activating ion; thickness: 80 nm; salt spray protection: 10-40 hours); and (5) clear chromates (silicofluoride activating ion; thickness: 50-150 nm; salt spray protection: 10-40 hours). Thick film trivalent passivate conversion coatings can be up to about 100 to 900 nm thick (Preikschat et. al. U.S. Pat. Nos. 6,287,704, 6,946,201, and 7,314,671). Chromate and trivalent conversion coatings have been viewed as barrier coatings as well as inhibitive coatings.

Conversion Coatings: Conversion coatings are generally produced by a reaction between a coating bath and the active-metal substrate in which insoluble or sparingly soluble compounds are precipitated on the surface of the substrate. Portions of the substrate are included in the reaction product which is the conversion coating itself; thus, the coating bath reacts (converts) with the substrate to form a conversion coating. As a result, the conversion coating is highly dependent on the reaction kinetics, which are, in turn, dependent on the bath pH, the time allotted for the reaction to occur, the temperature, the concentration of each of the active species of the passivating bath, the complexing agents (if any) present in the conversion coating bath, and many other factors. Generally, conversion coatings are resistant to wiping (phosphates and trivalent passivates are quite resistant to wiping; conventional chromates are less resistant to wiping but still sufficiently adherent to be handled in bulk processes such as barrel zinc plating followed by chromating). Conversion coatings cannot be rinsed off with water, which is for all practical purposes the only solvent which is widely used for this process. Essentially all commercial chromate conversion coatings are rinsed after they are produced; if they are not rinsed, or if they are not thoroughly rinsed, the presence of residual salts (e.g., activating salts serving as the source of the activating ion in the conversion bath) on the surface of the treated article can lead to unsatisfactory corrosion protection. Specifically, when water vapor condenses on the treated article, the water re-dissolves the contaminating salts (e.g., in a process quite similar to the corrosion process in the salt spray cabinet), thus triggering the corrosion of the zinc (or other active metal), resulting in premature failure. This is not a rare problem for commercial platers, so rinsing is viewed as a necessary step in the industrial practice of producing conversion coatings on active metals.

No-Rinse Coatings: No-rinse coatings such as paints and lacquers do not react with their substrate; essentially none of the substrate is incorporated in the conventional coating. No-rinse coatings require a binder to affix components of coatings to substrate. No-rinse coatings may be wiped off immediately after application and before drying. They may be easily rinsed off with the solvent utilized in the coating. The coating weight obtained from conventional coatings is independent of immersion time. However, if the coating is applied as a dip-spin coating, either in specially designed equipment or in a centrifugal dryer, the amount of coating remaining on the surface is dependent on the centripetal force applied to the articles. For dip-drain processes as well as for dip-spin processes, the coating weight is dependent on the solids loading of the coating as well as the thixotropy and the viscosity of the coating material.

Hexavalent chromium has long been recognized as hazardous, toxic and carcinogenic. An impetus for the reduction and/or elimination of hexavalent chromium has come from Europe, where the European Union has addressed the issue of the recycling and/or disposal of automobiles at the end of their useful lives. The original directive (Directive 2000/53/EC of the European Parliament and of the Council of Sep. 18, 2000 on End-of-Life Vehicles; “ELV”) limited hexavalent chromium to 2.0 grams per vehicle, but only for the purpose of corrosion protection; all other uses were prohibited.

High-performance trivalent passivates (e.g., those that provide over 24 hours to white corrosion in the ASTM B-117 Salt Spray Test) have been viewed as an alternative to hexavalent chromium conversion coatings. However, trivalent passivates have had significant operational limitations since their introduction. The best-performing (i.e., those that provide the best protection in the ASTM B-117 Salt Spray Test) formulations of these conversion coating baths require operation at an elevated temperature, which is a difficulty in itself. The high operational temperature also results in increased zinc (or other active metal) levels in the bath, as zinc from the metal substrate (e.g., as a sacrificial coating) is dissolved by the acids in the conversion coating bath, which generally have pH values slightly above 2. These high zinc levels result in significantly diminished performance as well as requiring frequent complete dumping of the baths. A further disadvantage of these baths is that they are relatively intolerant of iron. Iron can contaminate trivalent passivating baths in two ways: (1) by the action of the passivating bath on parts which have inadvertently dropped in the bath, and (2) by the action of the passivating bath on a zinc deposit with codeposited iron; this occurs when the electroplating bath is contaminated with iron (and may occur with other zinc deposition processes as well). An additional disadvantage of these baths is that their makeup (e.g., the preparation of the chromate conversion coating bath) is generally significantly higher than older hexavalent chromates. Prior art hexavalent chromates are made up at about 1% by volume; trivalent passivates are made up at approximately 10% to 18% by volume. The dragout from these baths is, therefore, significantly higher as well. An additional disadvantage of these baths is that most of these baths incorporate chelating or complexing agents (e.g., dibasic organic acids such as oxalic or malonic acids), thus interfering with waste treatment by formation of complexes with metals that would otherwise be precipitated by alkaline treatment. A further disadvantage of these conversion coatings is that the resulting conversion coating is extremely susceptible to abrasion, being composed of friable inorganic compounds. This is particularly disadvantageous when articles such as nuts, machines screws, and other fasteners are exposed to vibratory handling. Further, failures of these coatings to meet salt spray requirements specified by customers are quite common.

3. Objects

One of the objects of the disclosure is to provide a corrosion-protection composition, film, and process which provides superior corrosion protection, particularly relative to trivalent passivates produced by a conversion coating process. Preferably, a corrosion-protected article according to the disclosure provides over 240 hours of corrosion protection to white rust in the ASTM B-117 Salt Spray Test without a topcoat.

Another object is to provide a corrosion-protection film and related article that elute less hexavalent chromium than comparable trivalent passivates (e.g., for a comparable level of corrosion protection, for example as measured by the salt spray test or other test method).

Yet another object is to provide a coating that is more resistant to physical damage. The polymeric binders included in the disclosed compositions and films have more physical strength than the friable inorganic compounds that constitute conventional conversion coatings.

A further object is to provide a process that is resistant to buildup of iron and/or zinc in the coating solution/bath. In conversion coatings over zinc, zinc from the substrate dissolves in the passivating bath, increasing the amount of zinc in the bath. As a dry-in-place coating, little zinc (or other active metal) is removed from the article to be passivated by the coating bath, and the amount of zinc removed from the coated substrate preferably is significantly reduced by raising the pH of the coating solution.

A still further object is to provide a corrosion-protection composition for active metals which may be colored (preferably with a dye) for article identification. Preferably, the color is applied in a single coating of the composition. There is a commercial need for such coatings (e.g., using green to indicate electrical grounds, blue for metric fasteners). Most commercial practice requires at least two dips or two coatings to achieve this object.

A further object is to provide a corrosion-resistant finish that does not require overplating of a sacrificial coating on the metallic substrate to be protected. For high-performance trivalent passivate conversion coatings, articles to be trivalent passivated often receive a zinc deposit that is approximately 20% to 40% thicker than ultimately required due to the amount of zinc removed during the passivation process. The disclosed compositions and methods do not substantially remove/dissolve sacrificial metals, therefore resulting in higher productivity and improved economics for the metal finisher.

Yet another object is to provide a coating which may be applied over many active metal surfaces; for example including aluminum, zinc (whether electrodeposited, hot-dip galvanized or mechanically plated), zinc-nickel (e.g., some hot-dip galvanizing and electroplated zinc-nickel), zinc-cobalt, zinc-iron (e.g., sherardizing and its recent variants, hot-dip galvanizing), electroplated zinc-iron, zinc-tin (mechanically plated or electroplated) zinc-lead (e.g., some hot-dip galvanizing), cadmium or magnesium or alloys of these compositions with other metals.

Yet another object is to provide a corrosion-protection composition that can be applied in a process substantially operated at room temperature. The most effective trivalent passivates on the market today are operated at an elevated temperature, which is a disadvantage for many platers. In addition, the high temperature results in increased attack on the zinc substrate, resulting in increased zinc levels in the passivating bath. This, in turn, results in decreased performance. Often, the only corrective action that may be taken is discarding the bath and making a new solution, which is an economic hardship for metal finishers.

A related object is to provide a corrosion-protection process that is reliable, requires a minimum of process control, and requires a minimum of technical support from the supplier. Conversion coatings (including thick-film trivalent conversion coatings in particular) require careful monitoring and adjustment of the active species in the bath, control over contaminating species such as zinc and iron, control over other process variables (e.g., pH, concentration, and temperature), and careful control over rinsing, which is often done in a counterflow (two-stage) process.

Yet another object is to provide a corrosion-protection composition that does not require chelators or complexing agents. Chelators and complexing agents result in a reduction in the ability of a surface finisher's waste- or water-treatment system to precipitate (and thus remove) heavy metals and have an adverse effect on the environment, as more heavy metals are introduced to the environment.

Yet another object is to reduce the water requirement of the corrosion-protection process when compared with trivalent conversion coating baths, in particular because a post-dip rinse is not required in the process.

Yet another object is to provide a corrosion-protection film that may be subsequently recoated, particularly with a coating of the same composition. Because conversion coatings are formed or produced by the reaction of the passivating bath with a substrate, a conversion coating prevents the formation of a second conversion coating of equal effectiveness over a previous conversion coating by interfering with the chemistry at the surface of the substrate where conversion coating would otherwise occur.

A further object is to provide a coating that gives the corrosion-protective performance of hexavalent chromates without including hexavalent chromium at the level of coating composition formulation and application.

Yet another object is to provide a corrosion-protection film whose coating weight (i.e., for a desired level of corrosion protection) is independent of the activity of the underlying substrate (e.g., zinc-nickel and other alloys have a lower activity than zinc and therefore produce a thinner conversion coating).

These and other objects may become increasing apparent by reference to the following description.

### SUMMARY

The disclosure relates to a corrosion-protection composition comprising: (a) water (optionally omitted for a dry formulation, but possibly including hydrated water); (b) a water-soluble trivalent chromium salt; (c) a water-soluble polymer (e.g., hot water-soluble, for example at >40° C., >50° C., >60° C., >70° C.); (d) optionally a second water-soluble, non-chromium, transition metal salt (e.g., cobalt salts, manganese salts, nickel salts, iron salts); (e) optionally a crosslinking agent (e.g., reactive with functional groups of the water-soluble polymer); and (f) optionally one or more additives selected from the group consisting of a coloring agent, a surfactant, and colloidal silica. The composition (i) is substantially free of hexavalent chromium; and (ii) is capable of forming a film on an active-metal substrate (e.g., zinc, aluminum, magnesium, cadmium, and combinations or alloys thereof) and is substantially non-reactive with the active-metal substrate.

Various embodiments of the disclosed compositions, methods, and articles are possible. The trivalent chromium salt can be present in the composition in an amount ranging from about 0.1 wt. % to about 20 wt. %, the polymer can be present in the composition in an amount ranging from about 0.1 wt. % to about 20 wt. %, the second salt can be present in the composition in an amount ranging from about 0.02 wt. % to about 5 wt. %, and/or the crosslinking agent can be present in the composition in an amount ranging from about 0.1 wt. % to about 5 wt. %. The trivalent chromium salt can be selected from the group consisting of chromium acetate, chromium chloride, chromium fluoride, chromium nitrate, chromium sulfate, chromium potassium sulfate, chromium picolinate, chromium ammonium sulfate, chromium bromide, chromium formate, chromium malonate, chromium succinate, and combinations thereof. The polymer can be selected from the group consisting of synthetic polymers, natural polymers, modified natural polymers, chemical derivatives and modifications thereof, and mixtures thereof (e.g., alkylcellulose, hydroxyalkylcellulose, hydroxyalkyl alkylcellulose, carboxyalkylcellulose, carrageenan, albumin, casein, gelatin, guar gum, gum agar, gum arabic, gum ghatti, gum karaya, gum tragacanth, hydrolyzed collagen, locust bean gum, natural gums, pectins, polyacrylamide, polyacrylic acid, polymethacrylic acid, polyethylene glycol, polyethyleneimine, polyethylene oxide, polysaccharides, polyvinyl alcohol, polyvinylpyrrolidone, starch and modified starch, synthetic water-soluble polymers, tamarind gum, xanthan gum, chemical derivatives of the foregoing, and mixtures of the foregoing). The second salt, when included, can comprise: (i) a cation selected from the group consisting of cobalt, manganese, nickel, iron, and combinations thereof; and (ii) an anion selected from the group consisting of nitrate, sulfate, chloride, fluoride, iodide, citrate, formate, oxalate, malonate, acetate, ammonium sulfate, succinate, and combinations thereof. The corrosion-protection composition preferably is substantially free of chelating agents.

The disclosure also relates to another embodiment of a corrosion-protection composition. The corrosion-protection composition consists essentially of: (a) water; (b) a first water-soluble trivalent chromium salt in an amount ranging from about 2 wt. % to about 15 wt. % of the composition, the trivalent chromium salt being selected from the group consisting of chromium acetate, chromium chloride, chromium fluoride, chromium nitrate, chromium sulfate, chromium potassium sulfate, chromium ammonium sulfate, chromium bromide, chromium formate, chromium malonate, chromium succinate, and combinations thereof; (c) a synthetic water-soluble polymer comprising hydroxyl functional groups, the polymer being present in an amount ranging from about 1 wt. % to about 10 wt. % of the composition; (d) a second water-soluble cobalt salt in an amount ranging from about 0.2 wt. % to about 3 wt. % of the composition, the cobalt salt being selected from the group consisting of cobalt nitrate, cobalt sulfate, cobalt chloride, cobalt fluoride, cobalt iodide, cobalt citrate, cobalt formate, cobalt oxalate, cobalt malonate, cobalt acetate, cobalt ammonium sulfate, cobalt succinate, and combinations thereof; (e) a crosslinking agent in an amount ranging from about 0.1 wt. % to about 5 wt. % of the composition, the crosslinking agent being selected from the group consisting of formaldehyde, glyoxal, glutaraldehyde, and combinations thereof; and (f) optionally one or more additives selected from the group consisting of a coloring agent, a surfactant, and colloidal silica. The corrosion-protection composition is characterized in that: (i) trivalent chromium from the trivalent chromium salt in the corrosion-protection composition represents at least about 95 wt. % of total chromium present in the composition; (ii) the composition is in the form of a solution having a pH ranging from about 3 to about 7; and (iii) the composition is capable of forming a film on an active-metal substrate and is substantially non-reactive with the active-metal substrate, the active-metal substrate comprising an active metal selected from the group consisting of zinc, aluminum, magnesium, cadmium, and combinations thereof. In an embodiment, the polymer is selected from the group consisting of alkylcellulose, hydroxyalkylcellulose, hydroxyalkyl alkylcellulose, carboxymethylcellulose, partially hydrolyzed polyvinyl alcohol, fully hydrolyzed polyvinyl alcohol, and combinations thereof.

The disclosure also relates to a method for applying a corrosion-protection film to a metallic substrate, the method comprising: (a) providing the corrosion-protection composition according to any of the disclosed embodiments; (b) applying the corrosion-protection composition to an active-metal substrate (e.g., at a temperature ranging from about 15° C. to about 30° C.), thereby forming a coated substrate, and (c) drying the coated substrate, thereby forming a corrosion-protected article comprising a corrosion-protection film (e.g., having a thickness of at least about 1 μm) adhered to the active-metal substrate, wherein: (i) trivalent chromium in the corrosion-protection composition does not substantially react with the active-metal substrate in step (b); and (ii) the applied corrosion-protection film is not removed from the active-metal substrate upon exposure of the corrosion-protected article to environmental moisture. The disclosure also relates to corrosion-protected articles formed according to any of the disclosed methods.

Various embodiments of the disclosed methods are possible. The active-metal substrate can comprise (i) an inner material comprising a ferrous metal or alloy thereof, and (ii) a sacrificial layer on an outer surface of the inner material, the sacrificial layer comprising the active metal. The active-metal substrate can be in the shape of one or more of nails, washers, bolts, screws, stampings, nuts, and lock-rings. Steps (b) and (c) can be performed one time each to form a corrosion-protected article comprising a single corrosion-protection film, or steps (b) and (c) can be performed two or more times each to form a corrosion-protected article comprising multiple layered corrosion-protection films. The method additionally can comprise: (d) applying a topcoat layer to the corrosion-protected article, the topcoat being selected from the group consisting of silicates, colloidal silica, lacquers, and paints. Preferably, the active-metal substrate is not rinsed in between steps (b) and (c).

The disclosure also relates to a corrosion-protected article comprising: (a) an active-metal substrate; and (b) a corrosion-protection film adhered to the active-metal substrate, the corrosion-protection film comprising: (i) a polymer matrix, (ii) a water-soluble trivalent chromium salt in the polymer matrix, (iii) optionally a second water-soluble salt in the polymer matrix, the second water-soluble salt being selected from the group consisting of cobalt salts, manganese salts, nickel salts, iron salts, and combinations thereof, and (iv) optionally a coloring agent; wherein: (i) the corrosion-protection film as prepared is substantially free of hexavalent chromium; (ii) trivalent chromium salt in the polymer matrix is unreacted with the active-metal substrate; and (iii) the corrosion-protection film is not removed from the from the active-metal substrate upon exposure of the corrosion-protected article to environmental moisture.

Various embodiments of the disclosed corrosion-protected articles are possible. The polymer matrix can comprise ionic crosslinks between trivalent chromium ions and polymer chains forming the polymer matrix. The polymer matrix can further comprise covalent crosslinks between polymer chains forming the polymer matrix, the covalent crosslinks comprising the reaction product of a crosslinking agent (e.g., aldehydes, dialdehydes, polyols) and functional groups on the polymer chains. The article can further comprise a topcoat layer adhered to the corrosion-protection film, (e.g., a topcoat selected from the group consisting of silicates, colloidal silica, lacquers, and paints). The applied corrosion-protection film can generate hexavalent chromium when the corrosion-protected article is subjected to a 24-hour ASTM B-117 salt spray chamber test. The corrosion-protected article can withstand at least about 96 hours of the ASTM B-117 salt spray chamber test while developing less than about 5% white (and/or red) corrosion on exposed surfaces of the corrosion-protected article.

All patents, patent applications, government publications, government regulations, and literature references cited in this specification are hereby incorporated herein by reference in their entirety. In case of conflict, the present description, including definitions, will control.

Additional features of the disclosure may become apparent to those skilled in the art from a review of the following detailed description, taken in conjunction with the examples, drawings, and appended claims, with the understanding that the disclosure is intended to be illustrative, and is not intended to limit the claims to the specific embodiments described and illustrated herein.

### BRIEF DESCRIPTION OF THE DRAWINGS

For a more complete understanding of the disclosure, reference should be made to the following detailed description and accompanying drawing wherein:

FIG. 1 illustrates a cross-sectional view of a corrosion-protected article formed according to the disclosed methods and with the disclosed compositions.

While the disclosed compositions and methods are susceptible of embodiments in various forms, specific embodiments of the disclosure are illustrated in the drawing (and will hereafter be described) with the understanding that the disclosure is intended to be illustrative, and is not intended to limit the claims to the specific embodiments described and illustrated herein.

### DETAILED DESCRIPTION

The present disclosure relates to a corrosion-protection composition that generally includes a water-soluble trivalent chromium salt and a water-soluble polymer. The composition preferably is in the form of an aqueous solution (i.e., the composition additionally includes water as a solvent) that can be applied to an active-metal substrate to form a coated substrate. Alternatively, the composition can be in a dry form or a highly concentrated aqueous mixture to which water is subsequently added to form the aqueous solution (e.g., prior to application on a substrate). Upon drying of the aqueous solution, the polymer and chromium salt form a corrosion-protection film (e.g., a matrix formed from the polymer with the chromium salt and any additional salts distributed therein) adhered to the active-metal substrate, where the corrosion-protection film and the active-metal substrate together form a corrosion-protected article. Optional ingredients in the corrosion-protection composition can include a second water-soluble salt (e.g., cobalt, manganese, nickel, and/or iron salts), a crosslinking agent, and/or a coloring agent. The corrosion-protection composition is substantially free of hexavalent chromium, capable of forming a film on an active-metal substrate (when in the form of an aqueous mixture), and is substantially non-reactive with the active-metal substrate (e.g., when applied to the substrate). Once applied, the corrosion-protection film is resistant to moisture (e.g., the film is not removed from the from the active-metal substrate upon exposure of the corrosion-protected article to moisture such as environmental moisture or moisture from a corrosion test).

The corrosion-protection composition represents a simple, reliable alternative to trivalent conversion coating baths. The composition, in the form of a mixture of a water-soluble polymer and a trivalent chromium compound, may be applied to an active-metal substrate and subsequently dried to provide a simple, straightforward and highly effective alternative to conversion coating baths (whether based on hexavalent chromium or trivalent chromium, or both). It is believed that the corrosion-protection film protects active metals by generating hexavalent chromium during the corrosion process from trivalent chromium distributed in the film's polymer matrix, a mechanism not recognized in relation to other trivalent conversion coatings.

The aqueous corrosion-protection composition may be described as a film-forming composition; once the composition is coated on a substrate and dried, it results in a film with structural integrity. By way of comparison, solutions of metal salts, once dried, are friable. A relatively small amount of water-soluble polymer may be used to provide the film-forming composition. For example, an aqueous solution including 0.41% polyvinyl alcohol, 7.24% chromium nitrate (Cr(NO₃)₃.6H₂O; concentration based on anhydrous weight) and 1.15% cobalt nitrate (Co(NO₃)₂.6H₂O; concentration based on anhydrous weight) may be cast on a glass plate and removed as a cohesive integral film with the use of a razor blade.

### Trivalent Chromium

The composition according to the disclosure includes trivalent chromium in a variety of forms. The trivalent chromium is suitably provided in the form of a trivalent chromium salt (anhydrous or hydrated), whether present in a dry formulation or a trivalent chromium source for an aqueous composition. In the aqueous composition, the trivalent chromium salt dissociates into its corresponding trivalent chromium (III) cation and associated anion. In the dried corrosion-protection film, the trivalent chromium remains primarily in its dissociated form (i.e., chromium (III) cations and the associated anions distributed throughout the film's polymer matrix). Thus, as used herein, the term “salt” (as applied to the trivalent chromium salt or other optional salt components described below) can refer to either (or both) of the ionic (solid) compound or the dissociated cations and anions.

In general, any trivalent chromium salt that is at least partially soluble in water is suitable for use according to the disclosure. Excellent results have been obtained with trivalent salts such as chromium fluoride, chromium chloride, chromium nitrate, chromium sulfate, chrome alum (chromium potassium sulfate), and chromium acetate. Chromium (III) picolinate, which is a dietary additive, generates hexavalent chromium when subjected to the ASTM B-117 Salt Spray test, and therefore could be a functionally effective source of trivalent chromium. Other suitable trivalent chromium salts include, by way of non-limiting examples, chromium ammonium sulfate, chromium bromide, chromium formate, chromium malonate, and chromium succinate. Mixed salts (i.e., those with more than one anionic moiety) also can be used.

The trivalent chromium salt can be incorporated into the corrosion-protection composition (whether in the form of an aqueous solution or a dry admixture of its components) in any amount desired, with increasing amounts generally providing an increased degree of corrosion protection to the final corrosion-protected article via the corrosion-protection film. In an aqueous corrosion-protection composition, the composition can include the trivalent chromium salt in an amount of at least 0.1 wt. % or 1 wt. % up to saturation, for example up to 8 wt. %, 10 wt. %, or 15 wt. %, based on the total composition weight (i.e., including the aqueous portion). Other suitable ranges include the trivalent chromium salt in an amount ranging from 0.1 wt. % to 20 wt. %, for example 2 wt. % to 15 wt. % or 5 wt. % to 10 wt. %. Alternatively or additionally, the aqueous corrosion-protection composition can be characterized in terms of the amount of the chromium (III) component (i.e., excluding the anionic portion of the trivalent chromium salt). For example, the composition can contain chromium (III) in an amount of at least 0.02 wt. % or 0.2 wt. % up to saturation, for example up to 1.6 wt. %, 2 wt. %, or 3 wt. %. Suitable ranges include the chromium (III) component in an amount ranging from 0.02 wt. % to 5 wt. %, for example 0.4 wt. % to 3 wt. % or 1 wt. % to 2 wt. %.

Trivalent chromium passivate conversion coatings have been regarded as barrier coatings, despite the fact that they are on the sub-micron scale (e.g., less than 900 nm in thickness). However, trivalent passivates have been found to offer no incremental protection in the Kesternich test, as described in ASTM G 87. This is due to the fact that the active corrosive agent in the Kesternich test (sulfur dioxide, SO₂) is also a very effective reducing agent for hexavalent chromium at the pH of the test. This finding provides evidence against the barrier layer theory. Instead, it is believed that trivalent passivate conversion coatings do not act as barrier coatings, but instead provide protection through the generation of hexavalent chromium in situ during the corrosion process. See, e.g., Rochester et al., “Unexpected Results from the Corrosion Testing of Trivalent Passivates” and Rochester et al., “Behavior of Trivalent Passivates in Accelerated Corrosion Testing,” both of which are incorporated herein by reference to the extent relevant.

Accordingly, it is believed that the corrosion-protection compositions and films according to the disclosure protect the underlying active-metal substrate via the oxidation of trivalent chromium to hexavalent chromium in an equilibrium reaction: Cr⁺³⇄Cr⁺⁶+3e⁻. Upon exposure to a source of corroding moisture and oxygen (e.g., environmental moisture such as rain or other precipitation, salt fog according to the salt spray test), trivalent chromium partially oxidizes to hexavalent chromium, thereby limiting or preventing a corrosive attack on the underlying active-metal substrate and/or steel/ferrous substrate (e.g., when the active-metal substrate is a sacrificial corrosion protection layer for the steel/ferrous substrate).

Because of the equilibrium relationship between trivalent chromium and hexavalent chromium, the corrosion-protection compositions and films according to the disclosure are preferably free (or substantially free) of hexavalent chromium as prepared. Compositions and films that are initially free of hexavalent chromium may develop hexavalent chromium through normal oxidation of trivalent chromium during storage or use of the composition. An absence (or minimal amount) of hexavalent chromium present in the composition promotes the conversion of trivalent chromium during the corrosion process. This feature can be expressed in terms of the fraction of total chromium present that is in the trivalent form. For example, trivalent chromium suitably represents at least 95 wt. %, 98 wt. %, 99 wt. %, 99.9 wt. %, or 99.95 wt. % of the total chromium present (e.g., trivalent and hexavalent chromium combined). Alternatively, hexavalent chromium suitably represents 5 wt. %, 2 wt. %, 1 wt. %, 0.1 wt. %, or 0.05 wt. % or less of the total chromium present.

### Polymer

The composition according to the disclosure includes any of a variety of water-soluble polymers. The water-soluble polymers generally include those that completely dissolve in water, at least partially dissolve in water, or form a stable dispersion in water. Some polymers according to the disclosure are slightly or sparingly soluble in cold water, but become increasingly soluble at warmer temperatures, for example being (substantially) completely soluble in hot water (e.g., at temperatures of at least 40° C., 50° C., 60° C., or 70° C.). The polymers are able to form a film on a substrate, for example when cast from an aqueous solution onto the substrate. It is believed that inclusion of trivalent chromium ions in a hydrophilic polymer matrix (e.g., resulting from the water-soluble polymer) that is sparingly soluble in water results in a rate of loss/release of the trivalent chromium ions from the corrosion-protection film, thus allowing the trivalent chromium in the coating to last longer as well as reducing the amount of hexavalent chromium eluted from the coating during corrosion under wet environments (e.g., including the ASTM B-117 Salt Spray Test).

The particular water-soluble polymers suitable for use are not particularly limited, for example generally including those described in detail in the Handbook of Water-Soluble Gums and Resins (McGraw-Hill, 1980), the Handbook of Industrial Water Soluble Polymers and Industrial Gums (Polysaccharides and Their Derivatives) (Academic Press, 1973), and Water-Soluble Synthetic Polymers: Properties and Behavior (CRC Press, 1983) (Volumes I and II), all of which are incorporated herein by reference in this application to the extent relevant. Many specific water-soluble polymers have been evaluated and found to be effective in compositions according to the disclosure. The water-soluble polymers generally include synthetic polymers, natural polymers, modified natural polymers, chemical derivatives and modifications thereof, and mixtures thereof. Representative synthetic polymers include vinyl polymers (e.g., polyvinyl alcohol (PVA; fully or partially hydrolyzed, including poly(vinyl alcohol-co-vinyl acetate), polyacrylamide, polyacrylic acid, polymethacrylic acid, polyvinylpyrrolidone), polyglycols (e.g., polyethylene oxide, polyethylene glycol, polypropylene glycol), polyethyleneimines (e.g., linear, branched). Representative natural polymers include proteins and/or hydrolyzed proteins (e.g., albumin, casein, gelatin, hydrolyzed collagen), gums (e.g., carrageenan, guar gum, gum agar (agar agar), gum arabic (acacia), gum ghatti, gum karaya, gum tragacanth, locust bean gum, natural gums, tamarind gum, xanthan gum), polysaccharides (e.g., starch, pectin). Representative (chemically) modified natural polymers include (chemically) modified starch and cellulose derivatives such as alkylcellulose (e.g., methylcellulose), hydroxyalkylcellulose (e.g., hydroxyethylcellulose, hydroxypropylcellulose), hydroxyalkyl alkylcellulose (e.g., hydroxyethyl methylcellulose), and carboxyalkylcellulose (e.g., carboxymethylcellulose; including salts thereof).

The water-soluble polymer can have one or more functional groups on its polymer chains (e.g., on the polymer backbone or on pendant side chains). The functional groups can impart hydrophilic character to the polymer; additionally, they can provide the ability to form ionic and/or covalent crosslinks in the polymer matrix forming the corrosion-protection film. Suitable functional groups are generally polar (e.g., to promote ionic crosslinking with cationic species in the composition) and/or reactive (e.g., to promote reactions with covalent crosslinking agents), for example including hydroxyl groups, carboxylic groups (including acids and salts thereof), amines, amides, and combinations thereof.

The selection of a particular water-soluble polymer is based on considerations of polymer stability, availability, cost, viscosity, and performance (e.g., corrosion resistance as measured by the salt spray test). The water-soluble polymer preferably exhibits resistance to destabilization in solution due to the ionic species present in the corrosion-protection composition. For example, alginates and methylcellulose, while usable in the corrosion-protection composition (e.g., at lower concentrations), can be precipitated by trivalent chromium salts and/or cobalt salts (e.g., when present at higher concentration). It is possible to include complexing agents and/or chelating agents in the corrosion-protection composition to limit or prevent such destabilization. However, the composition preferably does not include complexing/chelating agents and includes a water-soluble polymer that is not subject to destabilization. While some water-soluble polymers are effective at increasing the viscosity of a solution including the polymer, the corrosion-protection composition preferably includes water-soluble polymers that do not substantially increase solution viscosity (e.g., to facilitate application and coating of the composition to a substrate). Additionally, it is desirable to include water-soluble polymers that do not react (even slowly) with the various inorganic salts.

Polyvinyl alcohol (PVA) is a water-soluble polymer having many favorable qualities in the disclosed compositions. PVA has a low solution viscosity relative to other water-soluble polymers with a high molecular weight and is soluble only in hot water (e.g., as a function of the degree of hydrolysis), thus increasing the cold-water resistance naturally (e.g., which cold-water resistance is generally imparted to the resulting corrosion-protection film). PVA forms ionic crosslinks with the inorganic salts incorporated into the composition (e.g., trivalent chromium salts). PVA is prepared by partial hydrolysis of polyvinyl acetate, and therefore PVA generally contains at least some non-hydrolyzed acetate groups. As used herein, PVA refers to a copolymer of polyvinyl alcohol and polyvinyl acetate, as is the convention. Polyvinyl alcohols are generally characterized according to their degree of hydrolysis (i.e., the fraction/percent of acetate groups which have been replaced by hydroxyl groups). PVA can be partially hydrolyzed (e.g., at least 80% degree of hydrolysis) or fully hydrolyzed (e.g., at least 95% degree of hydrolysis, generally being 98%-99% hydrolyzed). Additionally, PVA is stable in the presence of many anionic and cationic moieties.

The water-soluble polymer can be incorporated into the corrosion-protection composition (whether in the form of an aqueous solution or a dry admixture of its components) in any amount desired, with an increasing concentration of the water-soluble polymer generally improving the corrosion protection performance of the resulting corrosion-protection film. In an aqueous corrosion-protection composition, the composition can include the polymer in an amount of at least 0.1 wt. % or 0.4 wt. % up to the gel point of the polymer in solution, for example ranging from 0.1 wt. % to 20 wt. %, 0.4 wt. % to 15 wt. %, 1 wt. % to 12 wt. %, 1 wt. % to 10 wt. %, or 2 wt. % to 10 wt. %. Alternatively or additionally, the corrosion-protection composition can be characterized in terms of the water-soluble polymer relative to the amount of the trivalent chromium component (e.g., either the anhydrous salt or the cationic portion). For example, the weight ratio of polymer to trivalent chromium salt can range from 0.1 to 10, 0.2 to 8, 0.3 to 5, or 0.4 to 2. Similarly, the weight ratio of polymer to trivalent chromium cation can range from 0.5 to 40, 1 to 30, 1.5 to 10, or 2 to 5.

### Non-Chromium Metals

The corrosion-protection performance of the disclosed compositions (and resulting films) can be enhanced by the incorporation of an additional, non-chromium metal salt into the composition. The additional salt generally has a transition metal cation and promotes (e.g., catalyzes, increases the rate of) the oxidation of trivalent chromium to hexavalent chromium in the corrosion-protection film. The transition metal is suitably a period 4 transition metal, for example including cobalt, manganese, nickel, iron, and combinations thereof. Essentially any anion forming a salt that is at least partially soluble in water can be used as the source of the additional, non-chromium metal. Examples of suitable anions include nitrate, sulfate, chloride, fluoride, iodide, citrate, formate, oxalate, malonate, acetate, ammonium sulfate, succinate, and combinations thereof.

In a limited number of examples (below), mechanically plated active-metal substrates treated with a corrosion-protection composition without the additional salt performed better in the salt spray test than those with the additional salt (e.g., cobalt in the examples). In general, however, the inclusion of the additional salt improved the corrosion protection. Moreover, in the examples, mechanically plated articles often exhibited a better salt spray protection than electroplated articles. In part, but only in part, this improvement can be attributed to the difference in thickness between the electroplated articles (0.0003 inch; 7.6 μm) and the mechanically plated articles (0.0005 inch; 12.7 μm).

The additional salt can be incorporated into the corrosion-protection composition (whether in the form of an aqueous solution or a dry admixture of its components) in any amount desired. Generally, the additional salt is included at a level lower than that of the trivalent chromium salt. In an aqueous corrosion-protection composition, the composition can include the additional salt in an amount ranging from 0.02 wt. % to 5 wt. %, 0.1 wt. % to 4 wt. %, 0.2 wt. % to 3 wt. %, or 0.5 wt. % to 2 wt. %. The aqueous corrosion-protection composition can be characterized in terms of the amount of the cationic component of the additional metal salt (e.g., the amount of a cobalt (II) cation excluding the anionic portion of the cobalt salt), for example ranging from 0.005 wt. % to 2 wt. %, 0.03 wt. % to 1.2 wt. %, 0.06 wt. % to 1 wt. %, or 0.1 wt. % to 0.6 wt. %. Alternatively or additionally, the corrosion-protection composition can be characterized in terms of the additional salt relative to the amount of the trivalent chromium component (e.g., either the anhydrous salt or the cationic portion). For example, the weight ratio of additional salt to trivalent chromium salt can range from 0.01 to 2, 0.02 to 1, 0.05 to 0.5, or 0.1 to 0.3. Similarly, the weight ratio of additional salt cation to trivalent chromium cation can range from 0.01 to 4, 0.02 to 2, 0.05 to 1, or 0.1 to 0.5.

### Additional Corrosion-Protection Composition Components

The water-soluble polymer in the corrosion-protection composition preferably becomes largely water-insoluble (e.g., completely water-insoluble, for example at low (ambient) temperatures common for environmental moisture) in the form of the corrosion-protection film applied to the active-metal substrate. Specifically, even though the polymer is initially water-soluble (e.g., partially, completely, or water-dispersible) in the aqueous corrosion-protection composition, the integrity and water-resistance of the polymer matrix forming the corrosion-protection film can be enhanced by ionic crosslinks between trivalent chromium ions (and potentially other metal cations in the composition, such as cobalt) and polar functional groups (e.g., hydroxyl, carboxylic) on polymer chains forming the polymer matrix. PVA is particularly suitable in this regard, because it is generally insoluble in cold water (e.g., depending on the degree of hydrolysis) and is further ionically crosslinked by trivalent chromium ions in the composition. However, polymers that retain at least some degree of their initial water solubility in the final corrosion-protection film can nonetheless provide effective corrosion protection and can be used in compositions according to the disclosure. Specifically, polymers that retain some water solubility in the corrosion-protection film are either nonetheless retained on their substrate or very slowly rinsed away from the substrate due to the relatively non-aggressive nature of some environmental moisture and the salt fog of the salt spray test.

Further crosslinking may be achieved with the inclusion of a covalent crosslinking agent in the corrosion-protection composition. The addition of the covalent crosslinker can improve the water-resistance and the salt spray protection of the resulting corrosion-protection film (e.g., an increase in the hours of salt spray protection ranging from 5% to 100%, 10% to 80%, or 20% to 60%, relative to the corrosion-protection composition without the covalent crosslinker). The specific type of the covalent crosslinking agent is not particularly limited, as long as the agent is di- or polyfunctional with respect to the functional group(s) of the water-soluble polymer (i.e., the agent is capable of reacting with multiple polymer functional groups). Thus, the selection of the covalent crosslinker depends on the functional groups of the polymer. Many of the suitable synthetic and natural water-soluble polymers (e.g., gums, PVA, cellulose derivatives, starch, starch derivatives) have hydroxyl groups and can be crosslinked with aldehydes (e.g., to form acetal links between neighboring chains) and/or dialdehydes (e.g., to form hemiacetal links between neighboring chains), for example including formaldehyde, glyoxal, and/or glutaraldehyde (glutaric dialdehyde). The aldehydes and dialdehydes can similarly be used to crosslink protein-based polymers. (Meth)acrylic acid polymers can be crosslinked with multifunctional alcohols (e.g., short-chain diols, polyols, glycols, polyglycols).

The covalent crosslinking agent can be incorporated into the corrosion-protection composition in any amount desired. However, many crosslinking agents are also reducing agents, and there may be the potential for the crosslinkers to limit the production of hexavalent chromium from trivalent chromium in the corrosion-protection film. Thus, the crosslinking agent is suitably included in an amount such that the crosslinking agent is substantially consumed in the formation of covalent crosslinks (i.e., there is little to no unreacted residual crosslinker in the polymer matrix of the corrosion-protection film). At the crosslinker levels evaluated in the examples (below), there does not appear to be any negative or inhibitory effect resulting from the inclusion of the covalent crosslinker. In an aqueous corrosion-protection composition, the composition can include the covalent crosslinking agent in an amount up to 5 wt. %, for example ranging from 0.1 wt. % to 5 wt. %, 0.2 wt. % to 4 wt. %, or 0.3 wt. % to 2 wt. %. Alternatively or additionally, the corrosion-protection composition can be characterized in terms of the amount of the covalent crosslinker relative to the amount of the water-soluble polymer. For example, the weight ratio of crosslinker to polymer can range from 0.001 to 0.5, 0.01 to 0.4, 0.1 to 0.4, or 0.1 to 0.3.

The corrosion-protection composition generally forms a stable mixture when in the form of an aqueous solution. Specifically, the trivalent chromium ions, other included metal ions, and any included covalent crosslinking agents do not substantially form ionic or covalent crosslinks in solution. For example, an aqueous corrosion-protection composition can remain stable for at least 30 days, 60 days, or 90 days and/or up to 120 days, 240 days, or 360 days without any substantial increase in solution viscosity (e.g., without gelling or without an increase in solution viscosity that would inhibit or prevent the application of the solution to a substrate). An appreciable degree of crosslinking occurs once the composition is applied to a substrate to form the corrosion-protection film (e.g., accelerating the crosslinking reactions as a result of drying/increasing component concentrations and/or increased temperature if heat is applied upon drying).

Other components may be included in the corrosion-protection composition. In some embodiments, the composition includes a coloring agent, such as a water-soluble dye (e.g., Direct Yellow 4, Acid Yellow 23, Acid Blue 9, Acid Violet 7, Acid Red 73, and Basic Green 1, with other conventional dyes possible) and/or a pigment. While nitrate salts of trivalent chromium and transition metals such as cobalt are suitably included in the corrosion-protection composition, the inclusion of additional nitrate salts (e.g., sodium nitrate or other alkali/alkali earth metal nitrates) does not appear to improve the performance of the corrosion-protection film with respect to white corrosion. However, the hours to red rust or base metal corrosion appear to be somewhat improved with the inclusion of such nitrates. While complexing agents and chelating agents (e.g., di- and/or polycarboxylic acids and derivatives thereof) may be added to the corrosion-protection composition, they do not generally improve the performance of the corrosion-protection film in the ASTM B-117 Salt Spray Test; thus, the corrosion-protection composition preferably is (substantially) free of the complexing/chelating agents, as they are not necessary (e.g., as in some trivalent chromium conversion coating processes). Surfactants/wetting agents (e.g., nonylphenolethoxylate, although the particular selection of surfactant is not particularly limited) can be included in minor amounts to improve both the solubilization of the polymer in the aqueous solution and the wetting of the resulting corrosion-protection composition on the active-metal substrate. Colloidal silica, in addition to its possible use as a topcoating composition (below), also can be included in the corrosion-protection composition, thus improving the resulting film. Colloidal silica, unlike alkali metal silicates, is stable for fairly long periods in the presence of cations that precipitate silicates when mixed with alkali metal silicates.

The corrosion-protection composition, when in the form of an aqueous solution or mixture (e.g., as applied to the active-metal substrate when forming the corrosion-protection film) can have any convenient pH. For example, the pH can be at least 2, 2.5, 3, 3.5, 4, 4.5, or 5. Additionally or alternatively, the pH can be 6, 6.5, or 7 or less. At low pH values (e.g., 3 or less), there can be some dissolution of the active metal (e.g., zinc) to which the corrosion-protection composition is applied. This can result, for example, in zinc buildup in the corrosion-protection composition bath. This accumulation of the active metal is an adverse outcome, because the active metal could be subsequently codeposited with the corrosion-protection composition. This phenomenon is slightly different from the incorporation of zinc in conversion coatings, where the zinc in the deposit is associated directly with the zinc on the article being passivated. At pH values above 7, there may be precipitation of the metals from the corrosion-protection composition, which is undesirable (but does not render the composition unusable). Thus, the aqueous compositions suitably have a pH ranging from 3, 3.5, or 4 to 6 or 7. In an embodiment, the pH of the corrosion-protection composition is adjusted to a desired value (e.g., 3.5+/−0.5) with an appropriate pH-adjusting agent (e.g., any suitable acid or base such an alkali metal hydroxide (sodium hydroxide) or a strong acid (nitric acid)). Suitably, the composition is free of acidic pH-adjusting agents, but optionally can include a basic pH-adjusting agent.

### Application of Corrosion-Protection Film

The corrosion-protection film can be formed on a metallic substrate by applying the corrosion-protection composition (e.g., according to any of its various embodiments) to an active-metal substrate (e.g., in the form of nails, washers, bolts, screws, stampings, nuts, and/or lock-rings), thereby forming a coated substrate. The composition may be applied by any convenient method, for example by (a) dipping/immersing the active-metal substrate in the composition and spinning the remainder of the composition off the substrate (i.e., a “dip-spin” method), (b) by dipping/immersing the active-metal substrate in the composition and draining the remainder off the substrate (i.e., a “dip-drain” method), or (c) by spraying the composition onto the substrate. As described above, the trivalent chromium in the corrosion-protection composition does not (substantially) react with the active-metal substrate in the application step. The corrosion-protection composition can be applied at any convenient temperature, for example at ambient temperatures (e.g., 15° C. to 40° C., 15° C. to 30° C., 20° C. to 25° C.) or at elevated temperatures (e.g., ambient up to 40° C., 50° C., 70° C. or 100° C.).

The coated substrate is then dried (preferably without an intervening rinse step between application and drying), thereby forming a corrosion-protected article having the corrosion-protection film adhered to the active-metal substrate. The corrosion-protection composition can be dried at any convenient temperature, for example at ambient temperatures (e.g., 15° C. to 40° C., 15° C. to 30° C., 20° C. to 25° C.) or an elevated temperatures (e.g., above ambient temperature, 50° C. or higher, 60° C. or higher, 95° C. or lower, and/or 100° C. or lower). The concentration of the composition components may be reduced with water (e.g., by diluting a stock solution containing the polymer and trivalent chromium salt at a high concentration) to obtain a desired weight (e.g., thickness or surface density) of the eventual corrosion-protection film. Suitably, the corrosion-protection film has an (average) thickness of at least 1 μm, 1.5 μm, 2 μm, 3 μm, or 5 μm. Similarly the corrosion-protection film can have an (average) thickness of 10 μm, 15 μm, or 20 μm or less.

The application and drying steps suitably can be performed one time each to provide a corrosion-protected article exhibiting sufficient corrosion resistance. Because the corrosion-protection composition is generally non-reactive, however, the application and drying steps can be performed multiple times in succession to build a corrosion-protection film from multiple layers (e.g., 2 to 10, 2 to 5 layers) of the salt-polymer composite. The resulting increased thickness of the corrosion-protection film generally provides an increased degree of corrosion protection (e.g., hours of resistance to the salt spray test).

The corrosion-protection film is generally in the form of a salt-polymer composite structure having (i) a polymer matrix (e.g., providing some adhesion of the film to the substrate), (ii) the water-soluble trivalent chromium salt in the polymer matrix, (iii) optionally the additional, non-chromium metal salt in the polymer matrix, and (iv) any other optional ingredients remaining from the corrosion-protection composition (e.g., the coloring agent). The polymer matrix forms from the water-soluble polymer as the water-soluble polymer dries. The polymer matrix additionally can include ionic crosslinks (e.g., between trivalent chromium ions and/or other metal cations and polar functional groups of the polymer chains) and/or covalent crosslinks (e.g., a reaction product of a di- or polyfunctional crosslinking agent and functional groups on adjacent polymer chains). The salts (trivalent chromium or otherwise) can be present in the polymer matrix in their ionic components (i.e., as a result of having been dissolved in the original aqueous corrosion-protection composition) and are generally immobilized or partially immobilized by the matrix. Mobility of the salts and their ionic constituents increases locally in the corrosion-protection film as water or other moisture is absorbed by the film, thus facilitating the oxidation of trivalent chromium to hexavalent chromium.

The applied corrosion-protection film in various embodiments is generally water-resistant; for example the film is not (substantially) removed from the active-metal substrate upon exposure of the corrosion-protected article to environmental moisture (e.g., rain or other precipitation, salt fog according to the salt spray test). Alternatively, the water-resistance can be characterized in terms of the temperature of hot water (e.g., a hot-water bath in which the corrosion-protected article is immersed for a period of minutes) that does not (substantially) dissolve or remove the corrosion-protection film from the active-metal substrate, for example water at 40° C., 50° C., 60° C., or 70° C. with immersion times of 1 min, 5 min, 10 min, 20 min, 30 min, or 60 min. Under such conditions, preferably at least 80 wt. %, 95 wt. %, 98 wt. %, 99 wt. %, or 99.9 wt. % of the corrosion-protection film (e.g., including the polymer, incorporated salts, etc.) remains adhered to the corrosion protection substrate.

The corrosion-protection film generates hexavalent chromium when the corrosion-protected article is subjected various forms of moisture, including the ASTM B-117 salt spray chamber test, other accelerated tests (excluding the Kesternich test, ASTM G87, or equivalents), and in natural environments. This property can be expressed conveniently as the number of hours (e.g., 24 hr, 48 hr, 72 hr) in which the corrosion-protected article is subjected to the salt spray chamber test with a positive result for the detection of hexavalent chromium (e.g., as an eluent or present in the corrosion-protection film). The corrosion-protection film generally produces less hexavalent chromium (e.g., as an eluent or in the film) than trivalent passivate conversion coatings for a comparable level of corrosion protection. For example, when measured by the salt spray test (or other test method), the corrosion-protection film produces less hexavalent chromium than a trivalent passivate conversion coating with the same or similar (e.g., within +/−5%, 10%) number of hours of salt spray protection. “Elution” refers to a phenomenon in which trivalent chromium corrosion coatings (e.g., films according to the disclosure or conversion coatings) can be placed in an ASTM B-117 salt spray chamber and exposed to a 5% salt fog spray, with the resulting condensate from the tested article being positive (either qualitatively or quantitatively) for hexavalent chromium (e.g., using tests based on 1,5-diphenylcarbazide).

The active-metal substrate can be formed substantially (or entirely) from the active metal. Alternatively, the active-metal substrate can include (i) an inner material formed from a ferrous metal or alloy thereof (including steel), and (ii) a sacrificial layer on an outer surface of the inner material, where the sacrificial layer includes the active metal. The ability of an active metal to provide sacrificial corrosion protection to iron, steel, or other iron-containing substrate can be characterized by the electrode potential of the active metal. The active metal generally has an electrode potential (E⁰) greater than that of iron or the underlying metal it protects (e.g., +0.44 V in acid solution for iron) to provide sacrificial protection to the iron or steel (e.g., as a mechanically plated or an electroplated outer layer of the active metal on the iron or steel substrate). If the electrode potential is too high, however, then the active metal can potentially react with water, thus rendering it ineffective. Common active metals suitable for use as substrates or sacrificial protectants for iron or steel within this disclosure include zinc, aluminum, magnesium, cadmium, and combinations/alloys thereof. Specific zinc alloys usable as active metals include zinc alloyed with one or more of cobalt, aluminum, iron, tin, lead, and nickel. The standard electrode potentials for common active metals are listed in Table 1. While cadmium has an electrode potential less than that of iron in the reference acid solution, cadmium is nonetheless considered to be sacrificial to iron in many environments (e.g., the corrosive conditions defined by the ASTM B-117 Salt Spray Test) and can be used as a sacrificial coating for steel (e.g., in industrial applications, especially aerospace).

TABLE 1
Oxidation-Reduction Potentials in Acid Solution

| Element - Ion Couple | E° (V) |
|---|---|
| Mg = Mg⁺⁺ + 2e⁻ | +2.37 |
| Al = Al⁺⁺⁺ + 3e⁻ | +1.63 |
| Zn = Zn⁺⁺ + 2e⁻ | +0.76 |
| Fe = Fe⁺⁺ + 2e⁻ | +0.44 |
| Cd = Cd⁺⁺ + 2e⁻ | +0.40 |
| Co = Co⁺⁺ + 2e⁻ | +0.28 |
| Ni = Ni⁺⁺ + 2e⁻ | +0.25 |

The corrosion-protection film provides a substantial resistance to corrosion for both the active-metal substrate and (if applicable) the underlying ferrous/steel substrate. This property can be expressed conveniently as the number of hours (e.g., at least 96 hr, 120 hr, 200 hr, 300 hr, 400 hr, 500 hr, or 600 hr; alternatively or additionally up to 1000 hr, 2000 hr, or 2000 hr) in which the corrosion-protected article is subjected to the salt spray chamber test with less than 5% white corrosion on exposed surfaces of the corrosion-protected article. Similar time ranges can apply for the appearance of 5% red corrosion on exposed surfaces of the corrosion-protected article, although generally longer times are required to exhibit red corrosion as compared to white corrosion. In the disclosed corrosion-protection films, there is generally no statistical correlation between the application (e.g., immersion) time during formation of the films and the resulting salt spray characteristics of the films, either to white or red corrosion. Further, there is generally no correlation between pH of the aqueous corrosion-protection composition and the resulting salt spray characteristics of the films. These observed properties disclosed compositions, methods, and articles illustrate the general non-reactive nature of the corrosion-protection composition components and the active-metal substrate.

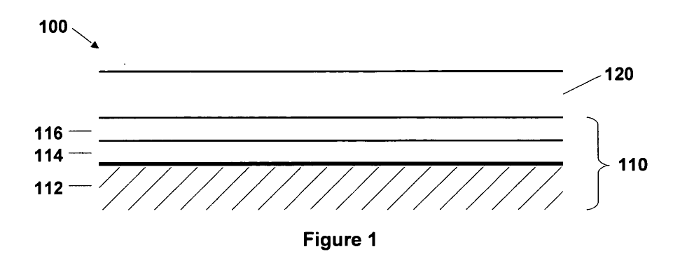

FIG. 1 illustrates a corrosion-protected article 100 according to the disclosure. The article includes an active-metal substrate 110. As illustrated, the active-metal substrate 110 includes a base metallic substrate 112 (e.g., iron, steel) and a sacrificial active metal layer 116. As further illustrated, the active-metal substrate 110 can include an optional intermediate layer 114, for example an immersion copper coating and/or a tin flash coating that promotes the adhesion of the sacrificial layer 116 to the base metallic substrate 112. As a result of the application and drying steps, a corrosion-protection film 120 forms and is adhered to the active-metal substrate 110 (e.g., to the sacrificial layer 116 as shown).

Even though the corrosion-protection film over the active-metal substrate provides excellent corrosion protection, the corrosion protection may be improved further by the application of an additional topcoat layer to the corrosion-protection film (e.g., similarly applied by dip-spin, dip-drain, or spraying methods). Suitable topcoating solutions can include silicates (e.g., sodium, potassium, and/or lithium silicates), colloidal silica, lacquers, and paints (i.e., a lacquer with an incorporated pigment or coloring agent). Soluble or dispersible silicates are particularly suitable, because silicates provide synergistic corrosion protection when coupled with the hexavalent-chromium-generating compositions of the disclosure, as may be seen from the examples (below). Specific suitable topcoats include silicate polymers such as those disclosed in Sutherland U.S. Pat. No. 4,657,599 (also called “leachant-sealants” or “sealants”) or a water-based lacquer.

### EXAMPLES

The following examples illustrate the disclosed compositions and methods, but are not intended to limit the scope of any claims thereto. Unless otherwise noted, the examples used chemicals obtained from Sigma-Aldrich (Milwaukee, Wis.) and were generally carried out according to the following methodology:

Except as noted, corrosion-protection compositions/solutions according to the disclosure were applied by dipping a ⅜″×2″ hex-head machine screw and a ⅜″ washer in the solution being tested with an immersion time generally ranging from about 20 sec to about 30 sec. The dipped articles were removed from the dipping solution and the remainder of the solution was removed by spinning in a centrifugal dryer (available from Nobles Mfg., St. Croix Falls, Wis.) at 1075 rpm and drying therein using heat (generally at about 140° F. (60° C.) or about 200° F. (93° C.) with a typical drying time of about 5 min) to form a dried corrosion-protection film adhered to the articles. The coating weight/thickness of the dried film may be adjusted by adjusting the rate of rotation and amount of centripetal force in the centrifugal dryer.

The corrosion protection solutions containing polyvinyl alcohol (PVA) were prepared from a stock solution of Elvanol 71-30 (DuPont; Wilmington, Del.; fully hydrolyzed polyvinyl alcohol having a 98%-99% degree of hydrolysis). A 5 wt. % stock PVA solution was prepared by dissolving 175 grams of Elvanol 71-30 in water to make 3500 ml of solution and then heating the solution to above 180° F. (82° C.) with agitation to dissolve the PVA, thus forming a clear aqueous PVA stock solution. The surfactant nonylphenolethoxylate (Igepal CO-730; Rohm and Haas; Philadelphia, Pa.) was added to improve the wetting of the particles PVA by the water; in addition, it is believed that the surfactant improves the wetting of the solution on a substrate. Trivalent chromium salts, other water-soluble salts, and other optional ingredients were then mixed and diluted with the PVA stock solution and to obtain corrosion protection solutions with a desired distribution of component concentrations. Stock solutions of the other water-soluble polymers were similarly prepared using conventional methods of mixing and/or heating, as required.

### The ASTM B-117 Salt Spray Test

In the ASTM B-117 Salt Spray Test, articles to be tested are subjected to neutral (i.e., pH between 6.5 and 7.2) salt fog including 5% salt (sodium chloride) and 95% water. Specimens generally are evaluated every 24 hours until failure. The visual appearance of white corrosion products (sometimes called “white rust”) indicates failure of the conversion or otherwise protective coating and the onset of the corrosion of the underlying zinc plating. The appearance of base metal corrosion (commonly called “red rust”) indicates failure of the zinc plating and the beginning of the corrosion of the article that had been plated or galvanized and then passivated (e.g., steel or other ferrous substrate). There is some correlation between the number of hours of white corrosion and the incremental improvement in the number of hours to red rust, but the correlation is imperfect.

The Salt Spray Test is commonly used for zinc and zinc alloy plating and coatings. Since coatings can provide years of corrosion resistance through the intended life of the part in use, it is necessary to have a predictive accelerated test, which allows scientists and engineers the opportunity to advance the development of new products more rapidly. The appearance of corrosion products (oxides) is evaluated after a period of time. Test duration depends on the corrosion resistance of the coating; the more corrosion-resistant the coating, the longer the period in testing without signs of corrosion. Salt spray testing is popular because it is cheap, quick, well standardized and reasonably repeatable. An approximate correlation is that one day of exposure in the salt spray cabinet is equivalent to a year of normal environmental exposure. There is an imperfect correlation between the duration in salt spray test and the expected life of a coating, since corrosion is a very complicated process and varies widely according to climate.

There are two ways of interpreting the beneficial effect of the disclosed corrosion-protection compositions when applied to an active-metal substrate and evaluated in the salt spray test. The first is the delay in the onset of the formation of white corrosion products (e.g., a mixture of zinc chloride, zinc carbonate, and zinc hydroxide (or hydrated zinc oxide) for zinc-based active-metal substrates). The second is the improvement in the number of hours to base metal corrosion (for zinc-plated steel parts, the formation of ‘red rust’ or iron oxide (FeO)). These two measures, as may be seen in the examples, are correlated imperfectly. In the examples, failure of the coating is defined as the number of hours required to generate white corrosion covering 5% of the exposed surface of the articles or the number of hours required to generate red rust (i.e., base metal corrosion) covering 5% of the exposed surface of the articles, accordingly. In practice, the presence of mere traces of white corrosion is an extremely variable and inconsistent endpoint for this test.

### 1,5-Diphenylcarbazide

Dissolved hexavalent chromium is most often identified by its reaction with diphenylcarbazide in acid solution. The pH is typically reduced with sulfuric acid or phosphoric acid, although other strong non-oxidizing acids are equally effective in this regard. This complex is not formed with trivalent chromium. The reaction is extremely sensitive, with the absorbency index per gram atom of chromium being about 40,000 at 540 nm. The 1,5-diphenylcarbazide test for hexavalent chromium is accepted on a worldwide basis as a robust test generally free from interferences, except by the European Union per se. Spot tests for hexavalent chromium have not proven to be reliable due to the strong possibility of false negatives. The preferred methods today include leaching the coating in water and testing the water for hexavalent chromium. Such methods are exemplified by ISO 3613 and GMW 3034, incorporated herein by reference.

### Example 1

### Kennedy Test for Hexavalent Chromium

Zinc-plated and subsequently trivalent passivated articles (⅜″×2″ machine screws) were placed in an operating ASTM B-117 Salt Spray Chamber with a drop of 1,5-diphenylcarbazide test solution prepared according to ISO 3613 3.3 applied to the surface of the article prior to introduction of the article into the salt spray cabinet. The articles were passivated with commercial trivalent passivates, including TRIDESCENT, TRIPASS, and HYPROBLUE (described below). After 24 hours, the plated and passivated articles were removed for inspection. Upon inspection, all trivalent passivates exhibited a reddish-violet coloration consistent with the production of hexavalent chromium. A control test, with no passivate of any kind, showed no reddish-violet color indicated the absence of hexavalent chromium.

### Example 2

### Rochester Test for Hexavalent Chromium

Zinc-plated and subsequently trivalent passivated articles (as formed in Example 1) were placed above a crystallizing dish and the assembly was introduced into an ASTM B-117 Salt Spray Cabinet. After 24 hours, the condensate from the articles in the dish was diluted to 50 ml with deionized water, tested for hexavalent chromium by acidifying with 1.5 ml of 4.5M sulfuric acid and adding 1 ml of a diphenylcarbazide solution prepared according to ISO 3613 3.4. The characteristic red-violet color of the hexavalent chromium complex developed, indicating the presence of hexavalent chromium in the condensate from the trivalent passivated articles. A control test, performed on plated articles with no passivate of any kind, showed no reddish-violet color when the condensate was tested.

### Examples 3-5

### Hexavalent Chromium Generation

In Example 3, a sample of 3d zinc-plated common nails weighing 260 grams (estimated surface area of 0.0671 m²) were treated with a commercially available trivalent passivate solution (TRIDESCENT available from Luster-On; West Springfield, Mass.; believed to include chromium(III) chloride hexahydrate, cobalt nitrate, sodium nitrate, and hydrochloric acid and have a pH of about 2) at 15% (v/v) make-up, at a solution temperature of 140° F., with 1 minute immersion time, and followed by rinsing. In Example 4, an equal weight of the same nails was coated with a solution of 4.13% polyvinyl alcohol, 7.24% chromium (III) nitrate (McGean Chemical; Cleveland, Ohio), and 1.15% cobalt nitrate (Shepherd Chemical; Cincinnati, Ohio) by immersing the nails in the solution, followed by spin-drying in a heated centrifugal dryer. In Example 5, an equal weight of the same nails was left untreated. These three samples were placed in a funnel lined with filter paper, and the funnel was placed above a beaker so as to capture the elution product. These three assemblies were then exposed to salt fog in an ASTM B-117 Salt Spray Cabinet for one week. After this period, the elution product was tested for hexavalent chromium using 1,5-diphenylcarbazide, and the hexavalent chromium production was calculated. Example 3 had a hexavalent chromium elution rate of 3744 μg/m²/week, Example 4 had a hexavalent chromium elution rate of 1207 μg/m²/week, and Example 5 produced a negative result for hexavalent chromium.

### Example 6

### Ionic Crosslinking

For Sample 1, a solution of 5% Elvanol 71-30 PVA was cast upon a polyethylene sheet and dried. For Sample 2, the PVA/Cr(III)/Co(II) solution of Example 4 was cast upon a polyethylene sheet and dried. The two dried films were then exposed to agitated water at a temperature of 140° F. (60° C.). After 20 minutes, the pure PVA film (Sample 1) had dissolved, while the chromium- and cobalt-containing PVA film (Sample 2) was intact, thus illustrating the formation of ionic crosslinks in the PVA and the resulting water insolubility of the chromium-containing film.

### Example 7

### Film Strength

A solution of 0.41% polyvinyl alcohol, 7.24% chromium (III) nitrate, and 1.15% cobalt nitrate was prepared and cast upon a polyethylene sheet and allowed to dry. The resulting film of Example 7 was found to be flexible and coherent. The film of Example 7 was found to have very little strength, however, and was therefore near a lower concentration limit for the polymer, which concentration is still able to form films of sufficient strength.

### Example 8

### Film Thickness

A sample of small stampings with a specific surface area of 3.50 ft²/lb of parts was treated with the solution of Example 7. Based on gravimetric calculations, the film coating weight was calculated to be 0.01125 oz/ft² (or 3.433 g/m²). The density of the film coating is estimated to be about 1.99 g/cm³, based on a weighted average of the coating components. The film coating weight and film density yield an estimated film coating thickness of 67.9×10⁻⁶ inch (or 1725 nm). Based on an oven solids value of about 15% and a coating solution specific gravity of about 1.09, the coverage of the coating is estimated to be 1940 ft²/gal (or 47.6 m²/l).

### Examples 9-14

### Colored Coating Solutions

Coating solutions according to Example 7 were supplemented with a small amount of water-soluble dye (Keystone Aniline Corp.; Chicago, Ill.), as indicated in Table 2. These solutions were then used to coat ⅜″×2″ zinc-electroplated machine screws. The resultant coating was pleasing and had sufficient depth of color to be utilized for identification. Examples 9 and 10 would be commercially acceptable as color matches for traditional hexavalent chromium yellow conversion coatings.

TABLE 2
Colored Coating Solutions

| Example | Dye | | | Amount |
|---|---|---|---|---|
| Example 9 | Direct Yellow 4 | CI 24890 | CAS 3051-11-4 | 0.60% |
| Example 10 | Acid Yellow 23 | CI 19140 | CAS 1934-21-0 | 0.50% |
| Example 11 | Acid Blue 9 | CI 42090 | CAS 2650-18-2 | 4.00% |
| Example 12 | Acid Violet 7 | CI 18055 | CAS 4321-69-1 | 0.90% |
| Example 13 | Acid Red 73 | CI 27290 | CAS 5413-75-2 | 0.80% |
| Example 14 | Basic Green 1 | CI 42040 | CAS 633-03-4 | 0.50% |

### Examples 15 and 16

### Aluminum Substrate

In Example 15, unanodized Aluminum washers were places in the Salt Spray Cabinet as reference samples. In Example 16, Aluminum washers were treated with the solution of Example 7, dried, and then placed in the ASTM B-117 Salt Spray Cabinet. Example 15 washers exhibited greater than 5% white corrosion at 120 hours, and Example 16 washers exhibited greater than 5% white corrosion at 192 hours.

### Examples 17-252

In the Examples and Comparative Examples which follow, each result represents one ⅜″×2″ machine screw and one ⅜″ washer treated with the indicated solution and then subjected to ASTM B-117 salt spray testing. The limited number of samples in each example can introduce experimental variability into the reported values. The screw/washer substrates in the various examples have either a mechanically plated (MP) or an electroplated (EP) sacrificial coating, or a hot-dip galvanized coating (HDG). MP Zinc was a mechanically deposited coating of zinc applied as disclosed in Rochester U.S. Pat. No. 5,762,942 and had a deposit thickness of 0.0005 inch (12.7 μm). EP Zinc was an electroplated deposit of zinc provided by Matthews Industries (Jackson, Mich.) and had a deposit thickness of 0.0003 inch (7.6 μm). MP Zinc-Aluminum was prepared according to Rochester U.S. Patent Application No. 2004/0043143 and had a deposit thickness of 0.0007 inch (17.8 μm). MP Cadmium was a mechanically deposited coating of cadmium per ASTM B-696 to a thickness of 0.0005 inch (12.7 μm). MP Zinc-Iron, Zinc-Cobalt, and Zinc Nickel were prepared according to Rochester U.S. Provisional Application No. 61/208,839 and had a deposit thickness of 0.0005 inch (12.7 μm).

Comparative Examples 17-52 (Chromated and Untreated Substrates): The results for the comparative examples (i.e., hours to 5% white and red corrosion) are shown in Table 3. The commercial trivalent passivate conversion coating TRIDESCENT was applied at 15% (v/v) of the commercial concentrate and 140° F. and a 1-minute immersion time, followed by careful rinsing. A conventional yellow chromate was made from 0.4% sodium chloride and 0.4% chromic acid (both obtained from Haviland Products; Grand Rapids, Mich.) in water; articles were then treated at room temperature in the chromate solution with an immersion time was 20 seconds, followed by careful rinsing. Another commercial trivalent passivate conversion coating CR3-140 (Camchem; Jackson, Mich.) was applied at room temperature at 11% (v/v) of the commercial concentrate and a 1-minute immersion time, followed by careful rinsing. Another commercial trivalent passivate conversion coating TRIPASS ELV (MacDermid, Inc.; Denver, Colo.) was applied at 120° F. with a 1-minute immersion time followed by careful rinsing. Another commercial trivalent passivate conversion coating HYPROBLUE (Pavco, Inc.; Charlotte, N.C.) was applied at 15% (v/v) at room temperature with a 1-minute immersion time, followed by careful rinsing. All samples were dipped in 0.25% nitric acid before applying the conversion coating.

TABLE 3
Comparative Examples 17-52

| | | | | 5% Red |
|---|---|---|---|---|
| | | | 5% White | Corro- |
| | | | Corrosion | sion |
| # | Substrate | Passivate | (hr) | (hr) |
| 17 | MP Zinc-Nickel | TRIDESCENT, 15% v/v | 672 | 1032 |
| 18 | MP Zinc-Aluminum | TRIDESCENT, 15% v/v | 1528 | 1656 |
| 19 | EP Zinc | TRIDESCENT, 15% v/v | 360 | 552 |
| 20 | MP Zinc-Cobalt | TRIDESCENT, 15% v/v | 168 | 360 |
| 21 | MP Zinc-Iron | TRIDESCENT, 15% v/v | 504 | 672 |
| 22 | MP Zinc | TRIDESCENT, 15% v/v | 528 | 624 |
| 23 | MP Zinc-Nickel | None (Control) | 72 | 120 |
| 24 | MP Zinc-Iron | None (Control) | 72 | 120 |
| 25 | MP Zinc-Cobalt | None (Control) | 72 | 120 |
| 26 | EP Zinc | None (Control) | 72 | 216 |
| 27 | MP Zinc-Aluminum | None (Control) | 72 | 432 |
| 28 | MP Zinc | None (Control) | 72 | 216 |
| 20 | EP Zinc | Yellow Chromate | 264 | 504 |
| 30 | MP Zinc | Yellow Chromate | 240 | 360 |
| 31 | MP Zinc-Cobalt | Yellow Chromate | 360 | 552 |
| 32 | MP Zinc-Nickel | Yellow Chromate | 576 | 648 |
| 33 | MP Zinc-Aluminum | Yellow Chromate | 384 | 648 |
| 34 | MP Zinc-Iron | Yellow Chromate | 456 | 552 |
| 35 | EP Zinc | CR3-140, 11% v/v | 332 | 408 |
| 36 | MP Zinc-Nickel | CR3-140, 11% v/v | 408 | 480 |
| 37 | MP Zinc-Iron | CR3-140, 11% v/v | 480 | 552 |
| 38 | MP Zinc | CR3-140, 11% v/v | 480 | 600 |
| 39 | MP Zinc-Cobalt | CR3-140, 11% v/v | 360 | 480 |
| 40 | MP Zinc-Aluminum | CR3-140, 11% v/v | 216 | 672 |
| 41 | MP Zinc-Nickel | TRIPASS ELV, 12% v/v | 360 | 360 |
| 42 | MP Zinc-Cobalt | TRIPASS ELV, 12% v/v | 360 | 432 |
| 43 | MP Zinc | TRIPASS ELV, 12% v/v | 384 | 360 |
| 44 | MP Zinc-Iron | TRIPASS ELV, 12% v/v | 360 | 360 |
| 45 | EP Zinc | TRIPASS ELV, 12% v/v | 264 | 336 |
| 46 | MP Zinc-Aluminum | TRIPASS ELV, 12% v/v | 360 | 480 |
| 47 | MP Zinc-Cobalt | HYPROBLUE, 15% v/v | 312 | 456 |
| 48 | EP Zinc | HYPROBLUE, 15% v/v | 360 | 384 |
| 49 | MP Zinc-Nickel | HYPROBLUE, 15% v/v | 384 | 384 |
| 50 | MP Zinc | HYPROBLUE, 15% v/v | 384 | 384 |
| 51 | MP Zinc-Iron | HYPROBLUE, 15% v/v | 384 | 360 |
| 52 | MP Zinc-Aluminum | HYPROBLUE, 15% v/v | 360 | 5053 |

Examples 53-252 (Examples According to the Disclosure): The compositions and results for the examples (i.e., hours to 5% white and red corrosion) are shown in Table 4. The “Notes” column of Table 4 indicates any additional components to the coating solution (e.g., covalent crosslinking agents) and/or modifications to the basic coating process described above (e.g., additional topcoating step, variation of existing steps). In the examples, the percentage of inorganic salt was corrected (if necessary) to the anhydrous form, even though the anhydrous form was used in only a few cases (i.e., the weight percents include both the weight of the cation and the anion, but exclude any hydrated water). The pH of the various compositions typically ranged from about 2.5 to about 3 (adjusted with sodium hydroxide), but was not generally measured in each instance. PVA (ELVANOL 71-30; fully hydrolyzed polyvinyl alcohol having a 98%-99% degree of hydrolysis) was obtained from DuPont (Wilmington, Del.). Chromium nitrate was obtained from McGean, Inc. (Cleveland, Ohio) as a solution. Cobalt nitrate was obtained from Shepherd Chemical (Norwood, Ohio). Gelatin was obtained from Knox Gelatin (Bohemia, N.Y.). NATROSOL LR was obtained from Hercules, Inc. (Wilmington, Del.). HEC 250LR hydroxyethylcellulose was obtained from Hercules as NATROSOL 250LR. ACRYSOL polyacrylic acid was obtained from Rohm and Haas, Inc. (Philadelphia, Pa.). Chromium Fluoride and Cobalt Fluoride were obtained from City Chemical (West Haven, Conn.). PVA/PVAc represents a partially hydrolyzed poly(vinyl alcohol/vinyl acetate) copolymer (i.e., an 86%-88% partially hydrolyzed polyvinyl acetate with a molecular weight of 146,000 to 186,000; available from Aldrich Chemical, DuPont). PEG 8000 (polyethylene glycol) was obtained from Union Carbide (Danbury, Conn.) as CARBOWAX 8000. Polyvinylpyrrolidone PVP K-30 was obtained from GAF Corporation (Wayne, N.J.). Albumin was obtained from the whites of farm eggs in Jackson, Mich. Sodium silicate was a mixture of Na₂O and SiO₂ (3.22:1 ratio) obtained from Haviland Products. Potassium silicate was obtained from PQ Corp. (Philadelphia, Pa.) as KASIL #1. “Solution A” was prepared from 15% v/v sodium silicate as above and 15% v/v acrylic colloidal polymer dispersion CARBOSET 511 (Noveon Corp.; Cleveland, Ohio). NALCO 1130 (aqueous dispersion of amorphous colloidal silica particles; also suitable for inclusion in the corrosion-protection solution) was obtained from Nalco Co. (Naperville, Ill.). The NALCO 1130 dispersion was an additive to the coating solution in some embodiments (Examples 109-112) and was used as a separate, topcoating composition in other embodiments (Examples 202-203).

TABLE 4
Examples 53-252

| | | | | | 5% White | 5% Red | |
|---|---|---|---|---|---|---|---|
| | | Polymer | | | Corrosion | Corrosion | |
| # | Substrate | Matrix | Cr(III) Salt | Other Salt | (hr) | (hr) | Notes |
| 53 | EP Zinc | PVA 71-30, | Cr(NO₃)₃, | Co(NO₃)₂, | 480 | 600 | |
| | | 4.13% | 7.24% | 1.15% | | | |
| 54 | MP Zinc- | PVA 71-30, | Cr(NO₃)₃, | Co(NO₃)₂, | 504 | 1008 | |
| | Cobalt | 4.13% | 7.24% | 1.15% | | | |
| 55 | MP Zinc- | PVA 71-30, | Cr(NO₃)₃, | Co(NO₃)₂, | 576 | 1008 | |
| | Aluminum | 4.13% | 7.24% | 1.15% | | | |
| 56 | MP Zinc- | PVA 71-30, | Cr(NO₃)₃, | Co(NO₃)₂, | 1896 | 1000+ | |
| | Iron | 4.13% | 7.24% | 1.15% | | | |
| 57 | MP Zinc- | PVA 71-30, | Cr(NO₃)₃, | Co(NO₃)₂, | 504 | 552 | |
| | Nickel | 4.13% | 7.24% | 1.15% | | | |
| 58 | MP Zinc | PVA 71-30, | Cr(NO₃)₃, | Co(NO₃)₂, | 528 | 672 | |
| | | 4.13% | 7.24% | 1.15% | | | |
| 59 | MP Zinc | PVA 71-30, | Cr(NO₃)₃, | Co(NO₃)₂, | 408 | 720 | |
| | | 4.13% | 7.24% | 1.15% | | | |
| 60 | EP Zinc | PVA 71-30, | Cr(NO₃)₃, | Co(NO₃)₂, | 408 | 528 | |
| | | 4.13% | 7.24% | 1.15% | | | |
| 61 | MP Zinc | PVA 71-30, | Cr(NO₃)₃, | Co(NO₃)₂, | 456 | 528 | |
| | | 3.72% | 6.52% | 1.04% | | | |
| 62 | EP Zinc | PVA 71-30, | Cr(NO₃)₃, | Co(NO₃)₂, | 360 | 528 | |
| | | 3.72% | 6.52% | 1.04% | | | |
| 63 | MP Zinc | PVA 71-30, | Cr(NO₃)₃, | Co(NO₃)₂, | 360 | 528 | |
| | | 3.30% | 5.79% | 0.92% | | | |
| 64 | EP Zinc | PVA 71-30, | Cr(NO₃)₃, | Co(NO₃)₂, | 360 | 504 | |
| | | 3.30% | 5.79% | 0.92% | | | |
| 65 | MP Zinc | PVA 71-30, | Cr(NO₃)₃, | Co(NO₃)₂, | 264 | 312 | |
| | | 2.89% | 5.07% | 0.81% | | | |
| 66 | EP Zinc | PVA 71-30, | Cr(NO₃)₃, | Co(NO₃)₂, | 168 | 360 | |
| | | 2.89% | 5.07% | 0.81% | | | |
| 67 | MP Zinc | PVA 71-30, | Cr(NO₃)₃, | Co(NO₃)₂, | 168 | 240 | |
| | | 2.48% | 4.34% | 0.69% | | | |
| 68 | EP Zinc | PVA 71-30, | Cr(NO₃)₃, | Co(NO₃)₂, | 192 | 312 | |
| | | 2.48% | 4.34% | 0.69% | | | |
| 69 | MP Zinc | PVA 71-30, | Cr(NO₃)₃, | Co(NO₃)₂, | 144 | 240 | |
| | | 2.07% | 3.62% | 0.58% | | | |
| 70 | EP Zinc | PVA 71-30, | Cr(NO₃)₃, | Co(NO₃)₂, | 144 | 264 | |
| | | 2.07% | 3.62% | 0.58% | | | |
| 71 | MP Zinc | PVA 71-30, | Cr(NO₃)₃, | Co(NO₃)₂, | 168 | 288 | |
| | | 1.65% | 2.90% | 0.46% | | | |
| 72 | EP Zinc | PVA 71-30, | Cr(NO₃)₃, | Co(NO₃)₂, | 148 | 288 | |
| | | 1.65% | 2.90% | 0.46% | | | |
| 73 | MP Zinc | PVA 71-30, | Cr(NO₃)₃, | Co(NO₃)₂, | 120 | 264 | |
| | | 1.24% | 2.17% | 0.35% | | | |
| 74 | EP Zinc | PVA 71-30, | Cr(NO₃)₃, | Co(NO₃)₂, | 168 | 312 | |
| | | 1.24% | 2.17% | 0.35% | | | |
| 75 | MP Zinc | PVA 71-30, | Cr(NO₃)₃, | Co(NO₃)₂, | 120 | 240 | |
| | | 0.82% | 1.45% | 0.35% | | | |
| 76 | EP Zinc | PVA 71-30, | Cr(NO₃)₃, | Co(NO₃)₂, | 120 | 240 | |
| | | 0.82% | 1.45% | 0.35% | | | |
| 77 | MP Zinc | PVA 71-30, | Cr(NO₃)₃, | Co(NO₃)₂, | 144 | 240 | |
| | | 0.41% | 0.72% | 0.12% | | | |
| 78 | EP Zinc | PVA 71-30, | Cr(NO₃)₃, | Co(NO₃)₂, | 120 | 264 | |
| | | 0.41% | 0.72% | 0.12% | | | |
| 79 | MP Zinc | Gelatin, 5% | Cr(NO₃)₃, | Co(NO₃)₂, | 1056 | 1248 | |
| | | | 7.24% | 1.15% | | | |
| 80 | EP Zinc | Gelatin, 5% | Cr(NO₃)₃, | Co(NO₃)₂, | 288 | 456 | |
| | | | 7.24% | 1.15% | | | |
| 81 | MP Zinc | Agar, 5% | Cr(NO₃)₃, | Co(NO₃)₂, | 984 | 1176 | |
| | | | 7.24% | 1.15% | | | |
| 82 | EP Zinc | Agar, 5% | Cr(NO₃)₃, | Co(NO₃)₂, | 432 | 480 | |
| | | | 7.24% | 1.15% | | | |
| 83 | MP Zinc | Natrasol LR, | Cr(NO₃)₃, | Co(NO₃)₂, | 1032 | 1344 | |
| | | 5% | 7.24% | 1.15% | | | |
| 84 | EP Zinc | Natrosol LR, | Cr(NO₃)₃, | Co(NO₃)₂, | 264 | 432 | |
| | | 5% | 7.24% | 1.15% | | | |
| 85 | MP Zinc | Acacia, 5% | Cr(NO₃)₃, | Co(NO₃)₂, | 384 | 480 | |
| | | | 7.24% | 1.15% | | | |
| 86 | EP Zinc | Acacia, 5% | Cr(NO₃)₃, | Co(NO₃)₂, | 288 | 480 | |
| | | | 7.24% | 1.15% | | | |
| 87 | MP Zinc | Xanthan | Cr(NO₃)₃, | Co(NO₃)₂, | 408 | 600 | |
| | | Gum, 5% | 7.24% | 1.15% | | | |
| 88 | EP Zinc | Xanthan | Cr(NO₃)₃, | Co(NO₃)₂, | 168 | 384 | |
| | | Gum 5% | 7.24% | 1.15% | | | |
| 89 | MP Zinc | Gum | Cr(NO₃)₃, | Co(NO₃)₂, | 1344 | 1728 | |
| | | Karaya, 2% | 7.24% | 1.15% | | | |
| 90 | EP Zinc | Gum | Cr(NO₃)₃, | Co(NO₃)₂, | 360 | 456 | |
| | | Karaya, 2% | 7.24% | 1.15% | | | |
| 91 | MP Zinc | PVA 71-30, | CrCl₃, | Co(NO₃)₂, | 984 | 1008 | |
| | | 4.13% | 2.82% | 1.83% | | | |
| 92 | EP Zinc | PVA 71-30, | CrCl₃, | Co(NO₃)₂, | 192 | 384 | |
| | | 4.13% | 2.82% | 1.83% | | | |
| 93 | MP Zinc | PVA 71-30, | Cr₂(SO₄)₃, | CoSO₄, | 576 | 648 | |
| | | 4.13% | 5.47% | 1.01% | | | |
| 94 | EP Zinc | PVA 71-30, | Cr₂(SO₄)₃, | CoSO₄, | 96 | 504 | |
| | | 4.13% | 5.47% | 1.01% | | | |
| 95 | MP Zinc | PVA 71-30, | Cr(C₂H₃O₂)₃, | Cr(C₂H₃O₂)₂, | 144 | 360 | |
| | | 4.13% | 9.09% | 1.82% | | | |
| 96 | EP Zinc | PVA 71-30, | Cr(C₂H₃O₂)₃, | Cr(C₂H₃O₂)₂, | 192 | 336 | |
| | | 4.13% | 9.09% | 1.82% | | | |
| 97 | MP Zinc | PVA 71-30, | Cr(NO₃)₃, | Co(NO₃)₂, | 696 | 960 | |
| | | 4.13% | 7.24% | 1.15% | | | |
| 98 | EP Zinc | PVA 71-30, | Cr(NO₃)₃, | Co(NO₃)₂, | 288 | 384 | |
| | | 4.13% | 7.24% | 1.15% | | | |
| 99 | MP Zinc | PVA 71-30, | Cr(NO₃)₃, | Co(NO₃)₂, | 936 | 960 | |
| | | 4.13% | 4.34% | 0.69% | | | |
| 100 | EP Zinc | PVA 71-30, | Cr(NO₃)₃, | Co(NO₃)₂, | 168 | 312 | |
| | | 4.13% | 4.34% | 0.69% | | | |
| 101 | MP Zinc | PVA 71-30, | Cr(NO₃)₃, | Co(NO₃)₂, | 1448 | 2000+ | |
| | | 4.13% | 7.24% | 0.69% | | | |
| 102 | EP Zinc | PVA 71-30, | Cr(NO₃)₃, | Co(NO₃)₂, | 504 | 816 | |
| | | 4.13% | 7.24% | 0.69% | | | |
| 103 | MP Zinc | PVA 71-30, | Cr(NO₃)₃, | Co(NO₃)₂, | 696 | 912 | |
| | | 2.48% | 7.24% | 1.15% | | | |
| 104 | EP Zinc | PVA 71-30, | Cr(NO₃)₃, | Co(NO₃)₂, | 120 | 288 | |
| | | 2.48% | 7.24% | 1.15% | | | |
| 105 | MP Zinc | PVA 71-30, | Cr(NO₃)₃, | (none) | 1368 | 2000+ | |
| | | 4.13% | 7.24% | | | | |
| 106 | EP Zinc | PVA 71-30, | Cr(NO₃)₃, | (none) | 96 | 288 | |
| | | 4.13% | 7.24% | | | | |
| 107 | MP Zinc | PVA 71-30, | Cr(NO₃)₃, | Mn(NO₃)₂, | 120 | 408 | |
| | | 4.13% | 7.24% | 0.65% | | | |
| 108 | EP Zinc | PVA 71-30, | Cr(NO₃)₃, | Mn(NO₃)₂, | 96 | 312 | |
| | | 4.13% | 7.24% | 0.65% | | | |
| 109 | MP Zinc | PVA 71-30, | Cr(NO₃)₃, | Co(NO₃)₂, | 1176 | 1704 | 10% Nalco 1130 |
| | | 4.13% | 7.24% | 1.15% | | | |
| 110 | EP Zinc | PVA 71-30, | Cr(NO₃)₃, | Co(NO₃)₂, | 600 | 960 | 10% Nalco 1130 |
| | | 4.13% | 7.24% | 1.15% | | | |
| 111 | MP Zinc | PVA 71-30, | Cr(NO₃)₃, | Co(NO₃)₂, | 696 | 1176 | 10% Nalco 1130 |
| | | 2.07% | 3.62% | 0.58% | | | |
| 112 | EP Zinc | PVA 71-30, | Cr(NO₃)₃, | Co(NO₃)₂, | 168 | 312 | 10% Nalco 1130 |
| | | 2.07% | 3.62% | 0.58% | | | |
| 113 | MP Zinc | PVA 71-30, | Cr(NO₃)₃, | Co(NO₃)₂, | 216 | 768 | |
| | | 4.13% | 14.48% | 2.30% | | | |
| 114 | EP Zinc | PVA 71-30, | Cr(NO₃)₃, | Co(NO₃)₂, | 336 | 792 | |
| | | 4.13% | 14.48% | 2.30% | | | |
| 115 | MP Zinc | PVA 71-30, | Cr(NO₃)₃, | Co(NO₃)₂, | 240 | 456 | |
| | | 3.72% | 13.03% | 2.07% | | | |
| 116 | MP Zinc | PVA 71-30, | Cr(NO₃)₃, | Co(NO₃)₂, | 264 | 552 | |
| | | 3.72% | 13.03% | 2.07% | | | |
| 117 | MP Zinc | PVA 71-30, | Cr(NO₃)₃, | Co(NO₃)₂, | 144 | 384 | |
| | | 3.30% | 11.58% | 1.84% | | | |
| 118 | EP Zinc | PVA 71-30, | Cr(NO₃)₃, | Co(NO₃)₂, | 168 | 312 | |
| | | 3.30% | 11.58% | 1.84% | | | |
| 119 | MP Zinc | PVA 71-30, | Cr(NO₃)₃, | Co(NO₃)₂, | 120 | 384 | |
| | | 2.89% | 10.14% | 1.89% | | | |
| 120 | EP Zinc | PVA 71-30, | Cr(NO₃)₃, | Co(NO₃)₂, | 120 | 456 | |
| | | 2.89% | 10.14% | 1.89% | | | |
| 121 | MP Zinc | PVA 71-30, | Cr(NO₃)₃, | Co(NO₃)₂, | 120 | 456 | |
| | | 2.48% | 8.69% | 1.38% | | | |
| 122 | EP Zinc | PVA 71-30, | Cr(NO₃)₃, | Co(NO₃)₂, | 168 | 432 | |
| | | 2.48% | 8.69% | 1.38% | | | |
| 123 | MP Zinc | PVA 71-30, | Cr(NO₃)₃, | Co(NO₃)₂, | 120 | 360 | |
| | | 2.07% | 7.24% | 1.15% | | | |
| 124 | EP Zinc | PVA 71-30, | Cr(NO₃)₃, | Co(NO₃)₂, | 144 | 288 | |
| | | 2.07% | 7.24% | 1.15% | | | |
| 125 | MP Zinc | PVA 71-30, | Cr(NO₃)₃, | Co(NO₃)₂, | 120 | 408 | |
| | | 1.65% | 5.79% | 0.92% | | | |
| 126 | EP Zinc | PVA 71-30, | Cr(NO₃)₃, | Co(NO₃)₂, | 120 | 240 | |
| | | 1.65% | 5.79% | 0.92% | | | |
| 127 | MP Zinc | PVA 71-30, | Cr(NO₃)₃, | Co(NO₃)₂, | 120 | 216 | |
| | | 1.24% | 4.34% | 0.69% | | | |
| 128 | EP Zinc | PVA 71-30, | Cr(NO₃)₃, | Co(NO₃)₂, | 120 | 144 | |
| | | 1.24% | 4.34% | 0.69% | | | |
| 129 | MP Zinc | PVA 71-30, | Cr(NO₃)₃, | Co(NO₃)₂, | 96 | 216 | |
| | | 0.82% | 2.90% | 0.46% | | | |
| 130 | EP Zinc | PVA 71-30, | Cr(NO₃)₃, | Co(NO₃)₂, | 96 | 216 | |
| | | 0.82% | 2.90% | 0.46% | | | |
| 131 | MP Zinc | PVA 71-30, | Cr(NO₃)₃, | Co(NO₃)₂, | 120 | 264 | |
| | | 0.41% | 1.45% | 0.23% | | | |
| 132 | EP Zinc | PVA 71-30, | Cr(NO₃)₃, | Co(NO₃)₂, | 120 | 216 | |
| | | 0.41% | 1.45% | 0.23% | | | |
| 133 | MP Zinc | PVA 71-30, | Cr(NO₃)₃, | Co(NO₃)₂, | 144 | 312 | Baked at 400° F. |
| | | 4.13% | 14.48% | 2.30% | | | for 1 hour |
| 134 | EP Zinc | PVA 71-30, | Cr(NO₃)₃, | Co(NO₃)₂, | 144 | 384 | Baked at 400° F. |
| | | 4.13% | 14.48% | 2.30% | | | for 1 hour |
| 135 | MP Zinc | PVA 71-30, | | Ce(NO₃)₆, | 24 | 96 | |
| | | 4.13% | | 7.51% | | | |
| 136 | EP Zinc | PVA 71-30, | | Ce(NO₃)₆, | 24 | 96 | |
| | | 4.13% | | 7.51% | | | |
| 137 | MP Zinc | PVA 71-30, | | (NH₄)₆Mo₇O₂₄, | 24 | 96 | |
| | | 4.13% | | 8.56% | | | |
| 138 | EP Zinc | PVA 71-30, | | (NH₄)₆Mo₇O₂₄, | 24 | 96 | |
| | | 4.13% | | 8.56% | | | |
| 139 | MP Zinc | PVA 71-30, | Cr(NO₃)₃, | Mn(NO₃)₂, | 48 | 456 | |
| | | 4.13% | 7.24% | 1.19% | | | |
| 140 | EP Zinc | PVA 71-30, | Cr(NO₃)₃, | Mn(NO₃)₂, | 120 | 288 | |
| | | 4.13% | 7.24% | 1.19% | | | |
| 141 | MP Zinc | PVA 71-30, | Cr(NO₃)₃, | Fe(NO₃)₂, | 120 | 336 | |
| | | 4.13% | 7.24% | 1.20% | | | |
| 142 | EP Zinc | PVA 71-30, | Cr(NO₃)₃, | Fe(NO₃)₂, | 120 | 264 | |
| | | 4.13% | 7.24% | 1.20% | | | |
| 143 | MP Zinc | PVA 71-30, | Cr(NO₃)₃, | NiCl₂, 1.09% | 144 | 504 | |
| | | 4.13% | 7.24% | | | | |
| 144 | EP Zinc | PVA 71-30, | Cr(NO₃)₃, | NiCl₂, 1.09% | 144 | 504 | |
| | | 4.13% | 7.24% | | | | |
| 145 | MP Zinc | PVA 71-30, | Cr(NO₃)₃, | Ce(NO₃)₃, | 144 | 432 | |
| | | 4.13% | 7.24% | 1.50% | | | |
| 146 | EP Zinc | PVA 71-30, | Cr(NO₃)₃, | Ce(NO₃)₃, | 144 | 336 | |
| | | 4.13% | 7.24% | 1.50% | | | |
| 147 | MP Zinc | PVA 71-30, | Cr(NO₃)₃, | Co(NO₃)₂, | 96 | 288 | |
| | | 4.13% | 0.72% | 0.12% | | | |
| 148 | EP Zinc | PVA 71-30, | Cr(NO₃)₃, | Co(NO₃)₂, | 144 | 288 | |
| | | 4.13% | 0.72% | 0.12% | | | |
| 149 | MP Zinc | PVA 71-30, | Cr(NO₃)₃, | Co(NO₃)₂, | 144 | 360 | |
| | | 3.30% | 0.58% | 0.10% | | | |
| 150 | EP Zinc | PVA 71-30, | Cr(NO₃)₃, | Co(NO₃)₂, | 96 | 288 | |
| | | 3.30% | 0.58% | 0.10% | | | |
| 151 | MP Zinc | PVA 71-30, | Cr(NO₃)₃, | Co(NO₃)₂, | 72 | 264 | |
| | | 2.89% | 0.50% | 0.08% | | | |
| 152 | EP Zinc | PVA 71-30, | Cr(NO₃)₃, | Co(NO₃)₂, | 168 | 336 | |
| | | 2.89% | 0.50% | 0.08% | | | |
| 153 | MP Zinc | PVA 71-30, | Cr(NO₃)₃, | Co(NO₃)₂, | 72 | 264 | |
| | | 2.48% | 0.43% | 0.07% | | | |
| 154 | EP Zinc | PVA 71-30, | Cr(NO₃)₃, | Co(NO₃)₂, | 48 | 216 | |
| | | 2.48% | 0.43% | 0.07% | | | |
| 155 | MP Zinc | PVA 71-30, | Cr(NO₃)₃, | Co(NO₃)₂, | 72 | 240 | |
| | | 2.07% | 0.36% | 0.06% | | | |
| 156 | EP Zinc | PVA 71-30, | Cr(NO₃)₃, | Co(NO₃)₂, | 48 | 240 | |
| | | 2.07% | 0.36% | 0.06% | | | |
| 157 | MP Zinc | PVA 71-30, | (None) | | 24 | 72 | |
| | | 4.13% | | | | | |
| 158 | EP Zinc | PVA 71-30, | (None) | | 24 | 72 | |
| | | 4.13% | | | | | |
| 159 | MP | PVA 71-30, | Cr(NO₃)₃, | Co(NO₃)₂, | 2000+ | 2000+ | |
| | Cadmium | 4.13% | 7.24% | 1.15% | | | |
| 160 | MP Zinc | PVA 71-30, | Cr(NO₃)₃, | Co(NO₃)₂, | 864 | 1056 | 0.5% Glutaric |
| | | 4.13% | 7.24% | 1.15% | | | Dialdehyde |
| 161 | EP Zinc | PVA 71-30, | Cr(NO₃)₃, | Co(NO₃)₂, | 576 | 1128 | 0.5% Glutaric |
| | | 4.13% | 7.24% | 1.15% | | | Dialdehyde |
| 162 | MP Zinc | PVA 71-30, | Cr(NO₃)₃, | Co(NO₃)₂, | 528 | 912 | 1.35% |
| | | 4.13% | 7.24% | 1.15% | | | Formaldehyde |
| 163 | EP Zinc | PVA 71-30, | Cr(NO₃)₃, | Co(NO₃)₂, | 480 | 768 | 1.35% |
| | | 4.13% | 7.24% | 1.15% | | | Formaldehyde |
| 164 | MP Zinc | PVA 71-30, | Cr(NO₃)₃, | Co(NO₃)₂, | 1104 | 1594 | 1.25% Glyoxal |
| | | 4.13% | 7.24% | 1.15% | | | |
| 165 | EP Zinc | PVA 71-30, | Cr(NO₃)₃, | Co(NO₃)₂, | 552 | 888 | 1.25% Glyoxal |
| | | 4.13% | 7.24% | 1.15% | | | |
| 166 | MP Zinc | PVA 71-30, | Cr(NO₃)₃, | Co(NO₃)₂, | 864 | 912 | 1% Glutaric |
| | | 4.13% | 7.24% | 1.15% | | | Dialdehyde |
| 167 | EP Zinc | PVA 71-30, | Cr(NO₃)₃, | Co(NO₃)₂, | 432 | 696 | 1% Glutaric |
| | | 4.13% | 7.24% | 1.15% | | | Dialdehyde |
| 168 | MP Zinc | HEC 250LR, | Cr(NO₃)₃, | Co(NO₃)₂, | 840 | 1128 | 1% Glyoxal |
| | | 4.13% | 7.24% | 1.15% | | | |
| 169 | EP Zinc | HEC 250LR, | Cr(NO₃)₃, | Co(NO₃)₂, | 552 | 936 | 1% Glyoxal |
| | | 4.13% | 7.24% | 1.15% | | | |
| 170 | MP Zinc | HEC 250LR, | Cr(NO₃)₃, | Co(NO₃)₂, | 504 | 768 | 1.35% |
| | | 4.13% | 7.24% | 1.15% | | | Formaldehyde |
| 171 | EP Zinc | HEC 250LR, | Cr(NO₃)₃, | Co(NO₃)₂, | 648 | 984 | 1% |
| | | 4.13% | 7.24% | 1.15% | | | Formaldehyde |
| 172 | MP Zinc | Gelatin, | Cr(NO₃)₃, | Co(NO₃)₂, | 216 | 624 | 1% Glutaric |
| | | 4.13% | 7.24% | 1.15% | | | Dialdehyde |
| 173 | EP Zinc | Gelatin, | Cr(NO₃)₃, | Co(NO₃)₂, | 336 | 984 | 1% Glutaric |
| | | 4.13% | 7.24% | 1.15% | | | Dialdehyde |
| 174 | MP Zinc | Gelatin, | Cr(NO₃)₃, | Co(NO₃)₂, | 552 | 984 | 1% |
| | | 4.13% | 7.24% | 1.15% | | | Formaldehyde |
| 175 | EP Zinc | Gelatin, | Cr(NO₃)₃, | Co(NO₃)₂, | 384 | 624 | 1% |
| | | 4.13% | 7.24% | 1.15% | | | Formaldehyde |
| 176 | MP Zinc | Gelatin, | Cr(NO₃)₃, | Co(NO₃)₂, | 528 | 864 | 1.25% Glyoxal |
| | | 4.13% | 7.24% | 1.15% | | | |
| 177 | EP Zinc | Gelatin, | Cr(NO₃)₃, | Co(NO₃)₂, | 432 | 600 | 1.25% Glyoxal |
| | | 4.13% | 7.24% | 1.15% | | | |
| 178 | MP Zinc | Acacia, | Cr(NO₃)₃, | Co(NO₃)₂, | 312 | 624 | 1% Glutaric |
| | | 4.13% | 7.24% | 1.15% | | | Dialdehyde |
| 179 | EP Zinc | Acacia, | Cr(NO₃)₃, | Co(NO₃)₂, | 400 | 864 | 1% Glutaric |
| | | 4.13% | 7.24% | 1.15% | | | Dialdehyde |
| 180 | MP Zinc | Acacia, | Cr(NO₃)₃, | Co(NO₃)₂, | 504 | 648 | 1.35% |
| | | 4.13% | 7.24% | 1.15% | | | Formaldehyde |
| 181 | EP Zinc | Acacia, | Cr(NO₃)₃, | Co(NO₃)₂, | 288 | 600 | 1.35% |
| | | 4.13% | 7.24% | 1.15% | | | Formaldehyde |
| 182 | MP Zinc | Acacia, | Cr(NO₃)₃, | Co(NO₃)₂, | 336 | 552 | 1.25% Glyoxal |
| | | 4.13% | 7.24% | 1.15% | | | |
| 183 | EP Zinc | Acacia, | Cr(NO₃)₃, | Co(NO₃)₂, | 336 | 552 | 1.25% Glyoxal |
| | | 4.13% | 7.24% | 1.15% | | | |
| 184 | MP Zinc | PVA 71-30, | Cr(NO₃)₃, | Co(NO₃)₂, | 288 | 552 | Single film layer |
| | | 4.13% | 7.24% | 1.15% | | | |
| 185 | EP Zinc | PVA 71-30, | Cr(NO₃)₃, | Co(NO₃)₂, | 432 | 752 | Single film layer |
| | | 4.13% | 7.24% | 1.15% | | | |
| 186 | MP Zinc | PVA 71-30, | Cr(NO₃)₃, | Co(NO₃)₂, | 840 | 1104 | 2 identical film |
| | | 4.13% | 7.24% | 1.15% | | | coats |
| 187 | EP Zinc | PVA 71-30, | Cr(NO₃)₃, | Co(NO₃)₂, | 384 | 720 | 2 identical film |
| | | 4.13% | 7.24% | 1.15% | | | coats |
| 188 | MP Zinc | PVA 71-30, | Cr(NO₃)₃, | Co(NO₃)₂, | 840 | 2000+ | 3 identical film |
| | | 4.13% | 7.24% | 1.15% | | | coats |
| 189 | EP Zinc | PVA 71-30, | Cr(NO₃)₃, | Co(NO₃)₂, | 384 | 1056 | 3 identical film |
| | | 4.13% | 7.24% | 1.15% | | | coats |
| 190 | MP Zinc | PVA 71-30, | Cr(NO₃)₃, | Co(NO₃)₂, | 840 | 2000+ | 4 identical film |
| | | 4.13% | 7.24% | 1.15% | | | coats |
| 191 | EP Zinc | PVA 71-30, | Cr(NO₃)₃, | Co(NO₃)₂, | 480 | 1104 | 4 identical film |
| | | 4.13% | 7.24% | 1.15% | | | coats |
| 192 | MP Zinc | PVA 71-30, | CrF₃, 5.52% | CoF₂, 1.83% | 648 | 1000+ | |
| | | 4.13% | | | | | |
| 193 | EP Zinc | PVA 71-30, | CrF₃, 5.52% | CoF₂, 1.83% | 144 | 600 | |
| | | 4.13% | | | | | |
| 194 | MP Zinc | Acrysol A-1, | Cr(NO₃)₃, | (None) | 72 | 120 | |
| | | 4.13% | 7.24% | | | | |
| 195 | EP Zinc | Acrysol A-1, | Cr(NO₃)₃, | (None) | 288 | 696 | |
| | | 4.13% | 7.24% | | | | |
| 196 | MP Zinc | Acrysol A-1, | Cr(NO₃)₃, | Co(NO₃)₂, | 120 | 360 | |
| | | 4.13% | 7.24% | 1.15% | | | |
| 197 | EP Zinc | Acrysol A-1, | Cr(NO₃)₃, | Co(NO₃)₂, | 312 | 648 | |
| | | 4.13% | 7.24% | 1.15% | | | |
| 198 | MP Zinc | PVA 71-30, | CrF₃, 2.76% | CoF₂, 0.92% | 384 | 888 | |
| | | 2.07% | | | | | |
| 199 | MP Zinc | PVA 71-30, | CrF₃, 2.76% | CoF₂, 0.92% | 240 | 480 | |
| | | 2.07% | | | | | |
| 200 | MP Zinc | PVA 71-30, | Cr(NO₃)₃, | Co(NO₃)₂, | 1200 | 2000+ | Sodium Silicate |
| | | 4.13% | 7.24% | 1.15% | | | Topcoat |
| 201 | EP Zinc | PVA 71-30, | Cr(NO₃)₃, | Co(NO₃)₂, | 624 | 1104 | Sodium Silicate |
| | | 4.13% | 7.24% | 1.15% | | | Topcoat |
| 202 | MP Zinc | PVA 71-30, | Cr(NO₃)₃, | Co(NO₃)₂, | 912 | 2000+ | Nalco 1130 |
| | | 4.13% | 7.24% | 1.15% | | | Topcoat |
| 203 | EP Zinc | PVA 71-30, | Cr(NO₃)₃, | Co(NO₃)₂, | 864 | 2000+ | Nalco 1130 |
| | | 4.13% | 7.24% | 1.15% | | | Topcoat |
| 204 | MP Zinc | PVA 71-30, | Cr(NO₃)₃, | Co(NO₃)₂, | 840 | 1440 | Potassium |
| | | 4.13% | 7.24% | 1.15% | | | Silicate Topcoat |
| 205 | EP Zinc | PVA 71-30, | Cr(NO₃)₃, | Co(NO₃)₂, | 288 | 912 | Potassium |
| | | 4.13% | 7.24% | 1.15% | | | Silicate Topcoat |
| 206 | MP Zinc | PVA 71-30, | Cr(NO₃)₃, | Co(NO₃)₂, | 912 | 2000+ | Topcoated w/ |
| | | 4.13% | 7.24% | 1.15% | | | Solution A |
| 207 | EP Zinc | PVA 71-30, | Cr(NO₃)₃, | Co(NO₃)₂, | 648 | 1128 | Topcoated w/ |
| | | 4.13% | 7.24% | 1.15% | | | Solution A |
| 208 | MP Zinc | PVA 71-30, | Cr(NO₃)₃, | Co(NO₃)₂, | 648 | 2000+ | pH adjusted to 3 |
| | | 4.13% | 7.24% | 1.15% | | | |
| 209 | EP Zinc | PVA 71-30, | Cr(NO₃)₃, | Co(NO₃)₂, | 432 | 768 | pH adjusted to 3 |
| | | 4.13% | 7.24% | 1.15% | | | |
| 210 | MP Zinc | PVA 71-30, | Cr(NO₃)₃, | Co(NO₃)₂, | 648 | 2000+ | pH adjusted to 4 |
| | | 4.13% | 7.24% | 1.15% | | | |
| 211 | EP Zinc | PVA 71-30, | Cr(NO₃)₃, | Co(NO₃)₂, | 336 | 528 | pH adjusted to 4 |
| | | 4.13% | 7.24% | 1.15% | | | |
| 212 | MP Zinc | PVA 71-30, | Cr(NO₃)₃, | Co(NO₃)₂, | 768 | 1344 | 5% Fe(NO₃) |
| | | 4.13% | 7.24% | 1.15% | | | 9H₂O |
| 213 | EP Zinc | PVA 71-30, | Cr(NO₃)₃, | Co(NO₃)₂, | 336 | 480 | 5% Fe(NO₃) |
| | | 4.13% | 7.24% | 1.15% | | | 9H₂O |
| 214 | MP Zinc | PVA 71-30, | Cr(NO₃)₃, | Co(NO₃)₂, | 360 | 504 | 5% Zn(NO₃) |
| | | 4.13% | 7.24% | 1.15% | | | |
| 215 | EP Zinc | PVA 71-30, | Cr(NO₃)₃, | Co(NO₃)₂, | 312 | 456 | 5% Zn(NO₃) |
| | | 4.13% | 7.24% | 1.15% | | | |
| 216 | EP Zinc | PVA 71-30, | Cr(NO₃)₃, | Co(NO₃)₂, | 96 | 336 | Rinsed 1 minute |
| | | 4.13% | 7.24% | 1.15% | | | |
| 217 | EP Zinc | PVA 71-30, | Cr(NO₃)₃, | Co(NO₃)₂, | 24 | 192 | Wiped and dried |
| | | 4.13% | 7.24% | 1.15% | | | |
| 218 | HDG | PVA 71-30, | Cr(NO₃)₃, | Co(NO₃)₂, | 168 | 1000+ | |
| | | 4.13% | 7.24% | 1.15% | | | |
| 219 | MP Zinc | PVA 71-30, | Cr(NO₃)₃, | Co(NO₃)₂, | 504 | 936 | |
| | | 3.30% | 7.24% | 1.15% | | | |
| 220 | EP Zinc | PVA 71-30, | Cr(NO₃)₃, | Co(NO₃)₂, | 576 | 1032 | |
| | | 3.30% | 7.24% | 1.15% | | | |
| 221 | MP Zinc | PVA 71-30, | Cr(NO₃)₃, | Co(NO₃)₂, | 576 | 960 | |
| | | 2.48 | 7.24% | 1.15% | | | |
| 222 | EP Zinc | PVA 71-30, | Cr(NO₃)₃, | Co(NO₃)₂, | 600 | 1080 | |
| | | 2.48% | 7.24% | 1.15% | | | |
| 223 | MP Zinc | PVA 71-30, | Cr(NO₃)₃, | Co(NO₃)₂, | 648 | 1000+ | |
| | | 1.65% | 7.24% | 1.15% | | | |
| 224 | EP Zinc | PVA 71-30, | Cr(NO₃)₃, | Co(NO₃)₂, | 432 | 648 | |
| | | 1.65% | 7.24% | 1.15% | | | |
| 225 | MP Zinc | PVA 71-30, | Cr(NO₃)₃, | Co(NO₃)₂, | 504 | 744 | |
| | | 0.83% | 7.24% | 1.15% | | | |
| 226 | EP Zinc | PVA 71-30, | Cr(NO₃)₃, | Co(NO₃)₂, | 384 | 576 | |
| | | 0.83% | 7.24% | 1.15% | | | |
| 227 | MP Zinc | PVA 71-30, | Cr(NO₃)₃, | Co(NO₃)₂, | 360 | 624 | |
| | | 0.41% | 7.24% | 1.15% | | | |
| 228 | EP Zinc | PVA 71-30, | Cr(NO₃)₃, | Co(NO₃)₂, | 408 | 720 | |
| | | 0.41% | 7.24% | 1.15% | | | |
| 229 | MP Zinc | PVA/PVAc, | Cr(NO₃)₃, | Co(NO₃)₂, | 720 | 1272 | |
| | | 4.13% | 7.24% | 1.15% | | | |
| 230 | EP Zinc | PVA/PVAc, | Cr(NO₃)₃, | Co(NO₃)₂, | 504 | 1032 | |
| | | 4.13% | 7.24% | 1.15% | | | |
| 231 | MP Zinc | PEG 8000, | Cr(NO₃)₃, | Co(NO₃)₂, | 192 | 480 | |
| | | 4.13% | 7.24% | 1.15% | | | |
| 232 | EP Zinc | PEG 8000, | Cr(NO₃)₃, | Co(NO₃)₂, | 288 | 552 | |
| | | 4.13% | 7.24% | 1.15% | | | |
| 233 | EP Zinc | PVA 71-30, | Cr(NO₃)₃, | Co(NO₃)₂, | 576 | 1224 | Immersed 1 |
| | | 4.13% | 7.24% | 1.15% | | | minute |
| 234 | EP Zinc | PVA 71-30, | Cr(NO₃)₃, | Co(NO₃)₂, | 480 | 744 | Immersed 2 |
| | | 4.13% | 7.24% | 1.15% | | | minutes |
| 235 | EP Zinc | PVA 71-30, | Cr(NO₃)₃, | Co(NO₃)₂, | 384 | 720 | Immersed 3 |
| | | 4.13% | 7.24% | 1.15% | | | minutes |
| 236 | EP Zinc | PVA 71-30, | Cr(NO₃)₃, | Co(NO₃)₂, | 456 | 840 | Immersed 4 |
| | | 4.13% | 7.24% | 1.15% | | | minutes |
| 237 | EP Zinc | PVA 71-30, | Cr(NO₃)₃, | Co(NO₃)₂, | 600 | 600 | Immersed 5 |
| | | 4.13% | 7.24% | 1.15% | | | minutes |
| 238 | EP Zinc | PVA 71-30, | Cr(NO₃)₃, | Co(NO₃)₂, | 456 | 1000+ | Immersed 6 |
| | | 4.13% | 7.24% | 1.15% | | | minutes |
| 239 | EP Zinc | PVA 71-30, | Cr(NO₃)₃, | Co(NO₃)₂, | 456 | 720 | Immersed 7 |
| | | 4.13% | 7.24% | 1.15% | | | minutes |
| 240 | EP Zinc | PVA 71-30, | Cr(NO₃)₃, | Co(NO₃)₂, | 312 | 912 | Immersed 8 |
| | | 4.13% | 7.24% | 1.15% | | | minutes |
| 241 | EP Zinc | PVA 71-30, | Cr(NO₃)₃, | Co(NO₃)₂, | 432 | 1008 | Immersed 9 |
| | | 4.13% | 7.24% | 1.15% | | | minutes |
| 242 | EP Zinc | PVA 71-30, | Cr(NO₃)₃, | Co(NO₃)₂, | 480 | 1008 | Immersed 10 |
| | | 4.13% | 7.24% | 1.15% | | | minutes |
| 243 | MP Zinc | PVP K-30, | Cr(NO₃)₃, | Co(NO₃)₂, | 384 | 624 | |
| | | 4.13% | 7.24% | 1.15% | | | |
| 244 | EP Zinc | PVP K-30, | Cr(NO₃)₃, | Co(NO₃)₂, | 456 | 744 | |
| | | 4.13% | 7.24% | 1.15% | | | |
| 245 | MP Zinc | PVA 71-30, | Cr(NO₃)₃, | Co(NO₃)₂, | 504 | 1272 | 5% Na(NO₃)₃ |
| | | 4.13% | 7.24% | 1.15% | | | |
| 246 | EP Zinc | PVA 71-30, | Cr(NO₃)₃, | Co(NO₃)₂, | 336 | 1128 | 5% Na(NO₃)₃ |
| | | 4.13% | 7.24% | 1.15% | | | |
| 247 | MP Zinc | PVA 71-30, | Cr(NO₃)₃, | Co(NO₃)₂, | 432 | 1128 | 10% Na(NO₃)₃ |
| | | 4.13% | 7.24% | 1.15% | | | |
| 248 | EP Zinc | PVA 71-30, | Cr(NO₃)₃, | Co(NO₃)₂, | 408 | 792 | 10% Na(NO₃)₃ |
| | | 4.13% | 7.24% | 1.15% | | | |
| 249 | MP Zinc | PVA 71-30, | (none) | Co(NO₃)₂, | 24 | 216 | |
| | | 4.13% | | 1.23% | | | |
| 250 | EP Zinc | PVA 71-30, | (none) | Co(NO₃)₂, | 24 | 192 | |
| | | 4.13% | | 1.23% | | | |
| 251 | MP Zinc | Albumin, 5% | Cr(NO₃)₃, | Co(NO₃)₂, | 456 | 912 | |
| | | | 7.24% | 1.15% | | | |
| 252 | EP Zinc | Albumin, 5% | Cr(NO₃)₃, | Co(NO₃)₂, | 456 | 1272 | |
| | | | 7.24% | 1.15% | | | |

Because other modifications and changes varied to fit particular operating requirements and environments will be apparent to those skilled in the art, the disclosure is not considered limited to the examples chosen for purposes of illustration, and covers all changes and modifications which do not constitute departures from the true spirit and scope of this disclosure.

Accordingly, the foregoing description is given for clarity of understanding only, and no unnecessary limitations should be understood therefrom, as modifications within the scope of the disclosure may be apparent to those having ordinary skill in the art.

Throughout the specification, where the compositions, processes, or apparatus are described as including components, steps, or materials, it is contemplated that the compositions, processes, or apparatus can also comprise, consist essentially of, or consist of, any combination of the recited components or materials, unless described otherwise. Component concentrations expressed as a percent are weight-percent (% w/w), unless otherwise noted. Moreover, weight values or weight-percents are expressed on a dry or anhydrous basis (e.g., for salts that are commercially available as hydrates or that form hydrates over time). Numerical values and ranges can represent the value/range as stated or an approximate value/range (e.g., modified by the term “about”). Combinations of components are contemplated to include homogeneous and/or heterogeneous mixtures, as would be understood by a person of ordinary skill in the art in view of the foregoing disclosure.

What is claimed is:

1. A corrosion-protection composition comprising:
(a) water;
(b) a water-soluble trivalent chromium salt;
(c) a water-soluble polymer;
(d) optionally a second water-soluble, non-chromium, transition metal salt;
(e) optionally a crosslinking agent; and
(f) optionally one or more additives selected from the group consisting of a coloring agent, a surfactant, and colloidal silica;
wherein:
(i) the composition is substantially free of hexavalent chromium; and
(ii) the composition is capable of forming a film on an active-metal substrate and is substantially non-reactive with the active-metal substrate.

2. The composition of claim 1, wherein the trivalent chromium salt is selected from the group consisting of chromium acetate, chromium chloride, chromium fluoride, chromium nitrate, chromium sulfate, chromium potassium sulfate, chromium picolinate, chromium ammonium sulfate, chromium bromide, chromium formate, chromium malonate, chromium succinate, and combinations thereof.

3. The composition of claim 2, wherein the trivalent chromium salt is present in the composition in an amount ranging from about 0.1 wt. % to about 20 wt. %.

4. The composition of claim 1, wherein the polymer is selected from the group consisting of synthetic polymers, natural polymers, modified natural polymers, chemical derivatives and modifications thereof, and mixtures thereof.

5. The composition of claim 4, wherein the polymer is present in the composition in an amount ranging from about 0.1 wt. % to about 20 wt. %.

6. The composition of claim 1, wherein the composition comprises the second salt, the second salt comprising: (i) a cation selected from the group consisting of cobalt, manganese, nickel, iron, and combinations thereof; and (ii) an anion selected from the group consisting of nitrate, sulfate, chloride, fluoride, iodide, citrate, formate, oxalate, malonate, acetate, ammonium sulfate, succinate, and combinations thereof.

7. The composition of claim 6, wherein the second salt is present in the composition in an amount ranging from about 0.02 wt. % to about 5 wt. %.

8. The composition of claim 1, wherein the composition comprises the crosslinking agent.

9. The composition of claim 8, wherein the crosslinking agent is reactive with functional groups of the polymer.

10. The composition of claim 8, wherein the crosslinking agent is present in the composition in an amount ranging from about 0.1 wt. % to about 5 wt. %.

11. The composition of claim 1, wherein the composition comprises the coloring agent, the coloring agent comprising a water-soluble dye.

12. The composition of claim 1, wherein the composition comprises the colloidal silica

13. The composition of claim 1, wherein the composition is substantially free of chelating agents.

14. The composition of claim 1, wherein the active-metal substrate comprises an active metal selected from the group consisting of zinc, aluminum, magnesium, cadmium, and combinations or alloys thereof.

15. A corrosion-protection composition consisting essentially of:
(a) water;
(b) a first water-soluble trivalent chromium salt in an amount ranging from about 2 wt. % to about 15 wt. % of the composition, the trivalent chromium salt being selected from the group consisting of chromium acetate, chromium chloride, chromium fluoride, chromium nitrate, chromium sulfate, chromium potassium sulfate, chromium ammonium sulfate, chromium bromide, chromium formate, chromium malonate, chromium succinate, and combinations thereof;
(c) a synthetic water-soluble polymer comprising hydroxyl functional groups, the polymer being present in an amount ranging from about 1 wt. % to about 10 wt. % of the composition;
(d) a second water-soluble cobalt salt in an amount ranging from about 0.2 wt. % to about 3 wt. % of the composition, the cobalt salt being selected from the group consisting of cobalt nitrate, cobalt sulfate, cobalt chloride, cobalt fluoride, cobalt iodide, cobalt citrate, cobalt formate, cobalt oxalate, cobalt malonate, cobalt acetate, cobalt ammonium sulfate, cobalt succinate, and combinations thereof;
(e) a crosslinking agent in an amount ranging from about 0.1 wt. % to about 5 wt. % of the composition, the crosslinking agent being selected from the group consisting of formaldehyde, glyoxal, glutaraldehyde, and combinations thereof; and
(f) optionally one or more additives selected from the group consisting of a coloring agent, a surfactant, and colloidal silica;
wherein:
(i) trivalent chromium from the trivalent chromium salt in the corrosion-protection composition represents at least about 95 wt. % of total chromium present in the composition;
(ii) the composition is in the form of a solution having a pH ranging from about 3 to about 7; and
(iii) the composition is capable of forming a film on an active-metal substrate and is substantially non-reactive with the active-metal substrate, the active-metal substrate comprising an active metal selected from the group consisting of zinc, aluminum, magnesium, cadmium, and combinations thereof.

16. The composition of claim 15, wherein the polymer is selected from the group consisting of alkylcellulose, hydroxyalkylcellulose, hydroxyalkyl alkylcellulose, carboxymethylcellulose, partially hydrolyzed polyvinyl alcohol, fully hydrolyzed polyvinyl alcohol, and combinations thereof.

17. A method for applying a corrosion-protection film to a metallic substrate, the method comprising:
(a) providing the corrosion-protection composition of claim 1;
(b) applying the corrosion-protection composition to an active-metal substrate, thereby forming a coated substrate, and
(c) drying the coated substrate, thereby forming a corrosion-protected article comprising a corrosion-protection film adhered to the active-metal substrate;
wherein:
(i) trivalent chromium in the corrosion-protection composition does not substantially react with the active-metal substrate in step (b); and
(ii) the applied corrosion-protection film is not removed from the active-metal substrate upon exposure of the corrosion-protected article to environmental moisture.

18. The method of claim 17, wherein the applied corrosion-protection film generates hexavalent chromium when the corrosion-protected article is subjected to a 24-hour ASTM B-117 salt spray chamber test.

19. The method of claim 17, wherein the corrosion-protected article is capable of withstanding at least about 96 hours of the ASTM B-117 salt spray chamber test while developing less than about 5% white corrosion on exposed surfaces of the corrosion-protected article.

20. The method of claim 17, wherein the active-metal substrate comprises an active metal selected from the group consisting of zinc, aluminum, magnesium, cadmium, and combinations thereof.

21. The method of claim 20, wherein the active-metal substrate comprises (i) an inner material comprising a ferrous metal or alloy thereof, and (ii) a sacrificial layer on an outer surface of the inner material, the sacrificial layer comprising the active metal.

22. The method of claim 17, wherein the active-metal substrate is in the shape of one or more of nails, washers, bolts, screws, stampings, nuts, and lock-rings.

23. The method of claim 17, wherein the corrosion-protection film has a thickness of at least about 1 μm.

24. The method of claim 17, comprising performing steps (b) and (c) one time each to form a corrosion-protected article comprising a single corrosion-protection film.

25. The method of claim 17, comprising performing steps (b) and (c) two or more times each to form a corrosion-protected article comprising multiple layered corrosion-protection films.

26. The method of claim 17, further comprising:
(d) applying a topcoat layer to the corrosion-protected article, the topcoat being selected from the group consisting of silicates, colloidal silica, lacquers, and paints.

27. The method of claim 17, wherein the active-metal substrate is not rinsed in between steps (b) and (c).

28. The method of claim 17, comprising performing step (b) at a temperature ranging from about 15° C. to about 30° C.

29. A corrosion-protected article comprising:
(a) an active-metal substrate; and
(b) a corrosion-protection film adhered to the active-metal substrate, the corrosion-protection film comprising: (i) a polymer matrix, (ii) a water-soluble trivalent chromium salt in the polymer matrix, (iii) optionally a second water-soluble salt in the polymer matrix, the second water-soluble salt being selected from the group consisting of cobalt salts, manganese salts, nickel salts, iron salts, and combinations thereof, and (iv) optionally a coloring agent;
wherein:
(i) the corrosion-protection film as prepared is substantially free of hexavalent chromium;
(ii) trivalent chromium salt in the polymer matrix is unreacted with the active-metal substrate; and
(iii) the corrosion-protection film is not removed from the from the active-metal substrate upon exposure of the corrosion-protected article to environmental moisture.

30. The article of claim 29, wherein the trivalent chromium salt is selected from the group consisting of chromium acetate, chromium chloride, chromium fluoride, chromium nitrate, chromium sulfate, chromium potassium sulfate, chromium picolinate, chromium ammonium sulfate, chromium bromide, chromium formate, chromium malonate, chromium succinate, and combinations thereof.

31. The article of claim 29, wherein the polymer matrix is derived from a polymer selected from the group consisting of alkylcellulose, hydroxyalkylcellulose, hydroxyalkyl alkylcellulose, carboxymethylcellulose, carrageenan, albumin, casein, gelatin, guar gum, gum agar, gum arabic, gum ghatti, gum karaya, gum tragacanth, hydrolyzed collagen, locust bean gum, natural gums, pectins, polyacrylamide, polyacrylic acid and homologs thereof, polymethacrylic acid, polyethylene glycol, polyethyleneimine, polyethylene oxide, polysaccharides, polyvinyl alcohol, polyvinylpyrrolidone, starch and modified starch, synthetic water-soluble polymers, tamarind gum, xanthan gum, chemical derivatives of the foregoing, and mixtures of the foregoing.

32. The article of claim 29, wherein the corrosion-protection film comprises the second water-soluble salt in the polymer matrix, the second salt comprising: (i) a cation selected from the group consisting of cobalt, manganese, nickel, iron, and combinations thereof; and (ii) an anion selected from the group consisting of nitrate, sulfate, chloride, fluoride, iodide, citrate, formate, oxalate, malonate, acetate, ammonium sulfate, succinate, and combinations thereof.

33. The article of claim 29, wherein the corrosion-protection film comprises the coloring agent, the coloring agent comprising a water-soluble dye.

34. The article of claim 29, wherein the polymer matrix comprises ionic crosslinks between trivalent chromium ions and polymer chains forming the polymer matrix.

35. The article of claim 30, wherein the polymer matrix further comprises covalent crosslinks between polymer chains forming the polymer matrix, the covalent crosslinks comprising the reaction product of a crosslinking agent and functional groups on the polymer chains.

36. The article of claim 35, wherein the crosslinking agent is selected from the group consisting of aldehydes, dialdehydes, polyols, and combinations thereof.

37. The article of claim 29, wherein the corrosion-protection film generates hexavalent chromium when the corrosion-protected article is subjected to a 24-hour ASTM B-117 salt spray chamber test.

38. The article of claim 29, wherein the corrosion-protected article is capable of withstanding at least about 96 hours of the ASTM B-117 salt spray chamber test with less than about 5% exposed surface exhibiting white corrosion.

39. The article of claim 29, wherein the active-metal substrate comprises an active metal selected from the group consisting of zinc, aluminum, magnesium, cadmium, and combinations thereof.

40. The article of claim 39, wherein the active-metal substrate comprises (i) an inner material comprising a ferrous metal or alloy thereof, and (ii) a sacrificial layer on an outer surface of the inner material, the sacrificial layer comprising the active metal.

41. The article of claim 29, wherein the active-metal substrate is in the shape of one or more of nails, washers, bolts, screws, stampings, nuts, and lock-rings.

42. The article of claim 29, wherein the corrosion-protection film has a thickness of at least about 1 μm.

43. The article of claim 29, further comprising a topcoat layer adhered to the corrosion-protection film, the topcoat being selected from the group consisting of silicates, colloidal silica, lacquers, and paints.
